(19) United States
(12) Patent Application Publication
(10) Pub. No.: US 2026/0270269 A1
(43) Pub. Date: Sep. 10, 2026

(54) SYSTEMS AND METHODS FOR CONTROLLED ACCESS TO NETWORK-BASED RESOURCES

(71) Applicant: THE BANK OF NEW YORK MELLON, New York, NY (US)

(72) Inventors: Christian Constantin ADAM, New York, NY (US); Jassem SHAKIL, New York, NY (US); Hamiz Nawaz KHAN, New York, NY (US); Yakov BORUKHOV, New York, NY (US); Mohamed SALMAN, New York, NY (US)

(21) Appl. No.: 19/081,155

(22) Filed: Mar. 17, 2025

Related U.S. Application Data
(63) Continuation of application No. 19/071,535, filed on Mar. 5, 2025.

(51) Int. Cl. H04L 9/40

(52) U.S. Cl. CPC H04L 63/102; H04L 63/108; H04L 47/40; H04L 63/10; H04L 63/101

(57) ABSTRACT

Provided is a system and method for controlling access to a network resource comprising: receiving, from a user computing device, a request to access a network resource; determining, with a computing system, that the network resource is an unclassified network resource; responsive to the determination the network resource is an unclassified network resource, classifying, by one or more machine learning model, the network resource with one or more classification; identifying, with the computing system, a category of action for access to the network resource based on the one or more classifications; and providing, with the user computing device, access to the network resource based on the category of action.

### CROSS-REFERENCE TO RELATED APPLICATIONS

This application is a Continuation Application of U.S. Ser. No. 19/071,535, filed Mar. 5, 2025, the entire contents of which is incorporated herein by reference in entirety.

### TECHNICAL FIELD

The present disclosure relates generally to network resource access control, and more particularly to systems and methods for enabling and/or disabling access to a network resource.

### BACKGROUND

An enterprise may permit access and connectivity to (e.g., allow employees, contractors, or other users to use) multiple network resources (e.g. a resource accessed over a network, such as an internal or external website), which may be resources within an internal (e.g., corporate) network—including internal resources accessed over an external network (such as corporate webpages accessed over the internet)—or external resources (e.g., external websites, servers, printers, etc.). The enterprise may have various levels of connectivity, such as allowing access to all internal network resources for internal users, or—as an example—blocking access to all external network resources for internal users. However, blanket permissions (e.g., permitting or blocking access) may hinder workflow, inspire work arounds, and compromise entity productivity, security, efficiency, etc. Within an internal network (or even for access points to external network resources), users may be permitted access to multiple network resources, which may be unnecessary (to the user, to the enterprise, etc.) or even present security risks if the internal network is compromised (such as by an outside user). The enterprise may not differentiate between internal network resources that a user needs, such as for performing enterprise related activities, internal network resources that a user may use (e.g., need) occasionally, internal resources that a user does not need access to (such as internal resources a user never needs or are outside the user's work scope), etc. From the internal network or on an enterprise device (such as a laptop, mobile phone, etc.), a user may be permitted access to multiple external network resources, which, likewise, may be permitted or denied in a binary (as a block list, allow list, or ON-OFF) manner and may not be treated based on the user and user's needs. That is, internally and externally, network connections (e.g., from a user to a network resource) and access and provision methods may not be distinguished by user identity, user intent, etc. Additionally, binary permission lists may fail to account for all network resources, as the number of network resources may grow as fast as or faster than they can be catalogued and classified as allowed or blocked. Permission lists may therefore be outdated or fail to adequately account for changes in internal and external resource content and permissibility.

Controlling access to network resources (e.g., websites, wireless networks, downloads, etc.) may often be a role, group, or network-based determination. For example, access may be restricted based on roles, assigned privileges, or location of individuals within an enterprise (e.g., internal users, external users such as VPN users, etc.). Users may be collectively permitted access to network resources that may be needed to perform relevant tasks and likewise restricted from access to network resources that do not pertain to them or represent security or other risks to the enterprise.

### SUMMARY

The following is a non-exhaustive listing of some aspects of the present techniques in accordance with various aspects of the present invention. These and other aspects are described in the following disclosure.

Some aspects include method for controlling access to a network resource comprising: receiving, from a user computing device, a request to access a network resource; determining, with a computing system, that the network resource is an unclassified network resource; responsive to the determination the network resource is an unclassified network resource, classifying, by one or more machine learning model, the network resource with one or more classification; identifying, with the computing system, a category of action for access to the network resource based on the one or more classifications; and providing, with the user computing device, access to the network resource based on the category of action.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

Features, aspects, and embodiments of the present disclosure are described in conjunction with the attached drawings, in which:

FIG. 1 is a schematic diagram depicting an example system for controlling access to network resources, in accordance with some embodiments of the present disclosure.

FIG. 2 depicts an example user browser graphical user interface (GUI), in accordance with some embodiments of the present disclosure.

FIG. 3A depicts an example user interface for a network resource request, in accordance with some embodiments of the present disclosure.

FIG. 3B depicts an example network resource request denial notification, in accordance with some embodiments of the present disclosure.

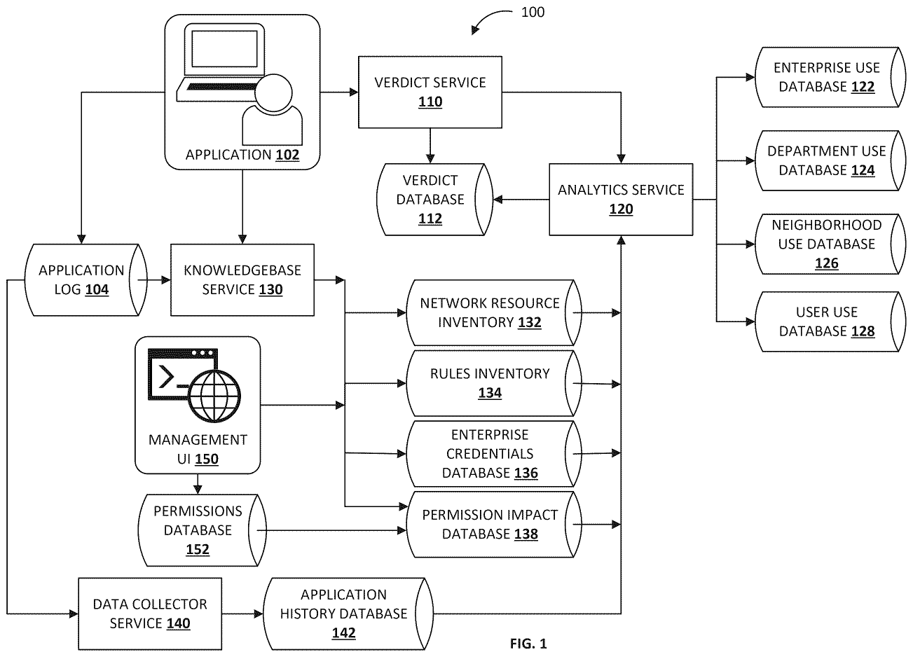

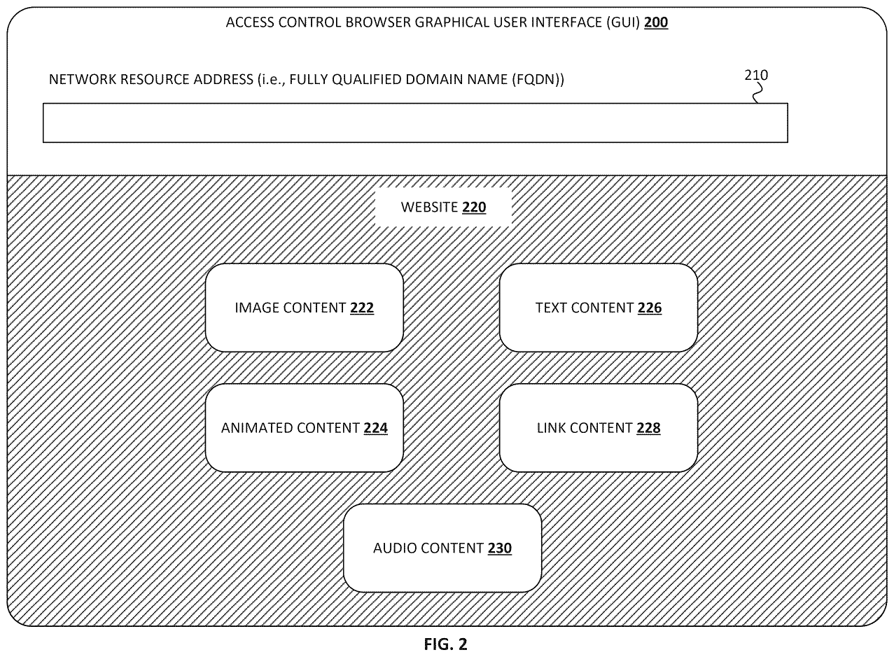

FIG. 1 4A depicts an example user interface for user verification, in accordance with some embodiments of the present disclosure.

FIG. 4B depicts an example network resource allowance notification, in accordance with some embodiments of the present disclosure.

FIGS. 5A-5F depict various example network resource notifications, in accordance with some embodiments of the present disclosure.

FIGS. 6A-6B depict an example user interface and alert, respectively, for step down of access to a network resource, in accordance with some embodiments of the present disclosure.

FIG. 7 is a flow chart illustrating a method for providing access to unclassified network resources, in accordance with some embodiments of the present disclosure.

FIG. 8 is a schematic diagram depicting an example browser extension system, in accordance with some embodiments of the present disclosure.

FIG. 9 is a flowchart illustrating a method for providing access to network resources, in accordance with some embodiments of the present disclosure.

FIG. 10 is a flowchart illustrating a method for classifying a network resource, in accordance with some embodiments of the present disclosure.

FIG. 11 is a flowchart illustrating a method for determining a risk level for a network resource, in accordance with some embodiments of the present disclosure.

FIG. 12 is an example of a data flow diagram of browsing enforcement based on key rotation in a multi-user network, in accordance with some embodiments of the present disclosure.

FIG. 13 illustrates an example of a method for browsing enforcement based on rotating key access in a multi-user network, in accordance with some embodiments of the present disclosure.

FIG. 14 illustrates a schematic example of proprietary code management with public application stores, in accordance with some embodiments of the present disclosure.

FIG. 15 is a schematic of a computing system, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of access control. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

While some of the embodiments below are described in relation to enabling of access to a network resource, a website, or other access control, it will be understood that the systems and methods described herein may apply equally to logging of access to a network resource, restricting of access to a network resource, enabling of partial access to a network resource, enabling of access to other external or internal resources, etc. Other resources may include, for example, wireless resources (e.g., including wireless printers, wireless monitors, etc.), Bluetooth resources, internal or external network resources accessed over a public network, internal or external network resources accessed over the enterprise network, internal or external network resources accessed over a user's home network, etc. Other operations may include provision of partial access or partial capabilities (e.g., downloading, uploading, printing, saving, etc.) to and from a network resource. Other operations may include monitoring, including, without limitation, using anomaly detection or behavior analysis, of network resource access, network resource cache, user behavior, change in user behavior, grouping of users based on user behavior, business unit, location, etc., controlling of user access to network resources based on membership of a user in one or more user group, to name just a few. Thus, the following descriptions should not be seen to limit the system, methods, and machine-readable medium described herein to any particular type of access enabling or restricting operation.

As discussed above, an enterprise may have various reasons for controlling access to one or more network resources (e.g., resources which are accessed over a network, which may be an internal or external or both an internal and external network). Internal network resources may be protected, such as by a firewall, password, etc. from external users, while internal users may be restricted from accessing one or more external network resources, including those which may be deemed unsafe or not business related-or of even just unknown or utility safety. Especially as remote users have increased, an enterprise may also have external network users (e.g., remote access users including enterprise users who are external or outside of the enterprise internal network, such as users working at home, users at client sites, etc.) who use an avenue to appear as internal network users (such as a virtual private network (VPN)). Traditionally, internal users, including remote access users who have passed one or more security checks and are treated as internal users, may have access to substantially all internal network resources, such as internal websites, drives, applications, etc. Within the internal network, internal users are generally not restricted from individual internal network resources, nor questioned as to why they need access to the individual internal network resources—access may be granted as a “blanket” or universal permission. This may present a security risk, as once a user is identified as a user on the internal network (including due to malicious behavior such as hacking, spoofing, etc.), they may access sensitive internal network resources.

In some cases, internal network users may be restricted from accessing some internal or external network resources, but may be able to request access. In some cases, external network users (which may include enterprise associated users on external networks) may be restricted from accessing some internal network resources but, may be able to request access. Most enterprises place at least some control on external network resources, such as by using one or more firewalls, but may allow users to request access to external network resources, such as external websites or web-based resources. In some cases, once access is requested (and approved) to a restricted internal or external network resource, the access to the resource may be indefinite (e.g., approved in perpetuity) and even if the network resource at the address changes. Security departments may review access (such as allow and block lists) periodically, such as every 6 months, if at all. The access may further be granted based on user characteristics, such as user membership in one or more groups, and may therefore grant access to a user who is a member of a given group, but who does not require such access. Access granted to a user may thereby weaken security controls, as a malicious actor acting as the user may inherit the permissions (e.g., network resource access) granted to the user who he is impersonating. The more users who have access to an internal network resource, such as an internal website, database, etc., the less secure that internal resource may be. Likewise, the more users who have access to an external network resource (and the more user-hours spent with access to that external network resource), the less secure the enterprise may be.

For these and other reasons, blanket access to network resources (or other internal or external resources) may be too broad an approach and may represent a security risk to an enterprise. However, restricted access (e.g., blocking access to the internal and external network resources) such as by removing the resources from the internal network, air-gapping resources on the internal network, blocking external resources, etc., may present challenges as access to such network resources may be needed by at least some users to complete enterprise-related tasks. For example, an enterprise may block user access to social media websites, such as for productivity reasons, to prevent confidential information being shared from enterprise devices, etc. But certain users (such as employees in marketing, communications, certain regulatory units, legal departments, etc.) may need access to such blocked social media websites in order to perform certain aspects of their jobs.

Granting access to users, such as those who need access to a network resource which is generally restricted, may be a time consuming and burdensome process, requiring multiple levels of approval, resource intensive on the security apparatus, irritating for users finding that they require more access than currently granted, etc. Herein, “security apparatus” is used to refer to information security, data security, physical security (e.g., physical access restriction), information technology (IT) and other security operations, departments, employees, and applications. A security apparatus may consist of multiple operators, both human and automated, such as under the direction of a security office, information security office, etc. Granting access to users may also be a static entitlement, e.g., granted for a particular network resource (or part thereof) and a particular time frame (which may be an indefinite or limited time). Because granting of access may be burdensome, both users and security apparatuses may be inclined to grant access for a longer time period that strictly needed, such as granting indefinite access to a network resource the user only needs to access for a limited time or occasionally. Such static access may present a security vulnerability, as it may linger beyond its necessary lifetime and present an unnecessary avenue for access, such as if a user identity is compromised or the content at located at the network resource address is changed (e.g., compromised).

Because of these and other reasons, a real-time, just-in-time, and just-enough-time access to a network resource presents a technical advancement. A system which can provide such access to one or more network resources, may further include authentication ability such as a strong authentication ability in which the system may verify that the user requesting access is in fact the user behind the request and is substantially not a malicious actor impersonating the user and requesting access. Such a system, and method of enabling access to a network resource, provides increased security while enabling enterprise tasks to be completed by users, including without significant imposition on the user. The enabling of access to network resources as needed and as-long-as needed, including with or without authentication of user identity, may have security benefits for enterprises.

Herein, “network resource” and grammatical variants thereof may be used to refer to any resource accessed over a network—that is, a resource accessed over a wired, wireless, protected, unprotected, etc. network from a user's individual computing device (e.g., laptop, desktop, mobile device, server, terminal, etc.). Network resources may include any resources outside of a user's computing device, such as shared servers, printers, instances of software applications, etc. Network resources may be websites or other interfaces used to access, process, etc. information provided on the web. In some embodiments, network resources may be or include resources physically stored, at least in part, on a user's device. Herein, “external” may be used to refer to networks, resources, databases, software, tools, internet sites, etc. which operate outside of an enterprise's network, proxy, firewall, control, etc. In some situations, certain external resources (e.g., external network resources) may be or may be assumed to be vulnerable to manipulation, including by malicious actors, which are not under the control of (or cannot be reasonable assumed to be under the control of) the enterprise. In some situations, certain external network resources may be or may be assumed to be detrimental to enterprise goals, for example, external network resources may include social media sites, job search sites, gambling sites, sites without appropriate security protocol, sites linked to phishing attempts, etc. “Internal” may be used to refer to networks, resources, databases, software, tools, etc. which operate inside of an enterprise's network, proxy, firewall, control, etc. In some situations, certain internal resources may be reasonably assumed to be under the control of the enterprise. In some situations, certain internal network resources may be or may be assumed to be vulnerable to attacks (e.g., inputting of erroneous data, denial of service attacks, etc.) or other behavior from internal users or others posing as internal users. In some situations, certain internal network resources may be restricted, such as for downloading, printing, etc., from users, while still being available to view or use. Internal network items and services may be protected, including from various subsets of users associated with the enterprise, such as by having restricted permissions, requiring logins, limiting access time, etc. The terms “internal” and “external” are not to be interpreted as restrictive of physical locations, as internal network resources may be hosted in one or more external physical locations (e.g., servers, databases, cloud services, service providers, etc.), while one or more external network resources may be accessed from one or more internal physical locations, such as from buildings controlled by the enterprise. In some cases, an enterprise network resource, such as one which is generally provided for external users (such as customers) may be considered an external network resource even if provided by the enterprise itself. Internal users may also include remote access users, such as users who VPN or otherwise enter an internal network. External users may include users physically present at an internal location, such as customers, contractors, trainees, etc. who are not registered users, may have access (such as restricted access) to an internal network.

FIG. 1 is a schematic diagram depicting an example system 100 for controlling access to network resources, in accordance with some embodiments of the present disclosure. An instance of the system 100 may operate on a user device, including within an application 102 on the user's device, or any other computing device which hosts the application 102, such as a server, a mobile device, etc. The system 100 may operate on or with (e.g., in communication with) multiple computing devices, including on a user's device, a server, a database, a processor, etc. The system 100 may include communication between multiple devices in any appropriate manner, including through wired or wireless connections, application programing interfaces (APIs), microservices, etc. The system 100 may include any appropriate hardware, software, processor, storage, communication bus, etc. The system 100 may operate on multiple user devices concurrently. The system 100 may operate on multiple instances of the application 102 concurrently. The system 100 may operate in any appropriate hardware configuration.

The application 102 may be a native application, e.g., an application built for a specific operating system, hardware, etc. or installed on a computing device itself, in full or in part. The application 102 may be a web application, e.g., an application accessed through a browser or other internet access application or without significant software installed on a computing device. The application 102 may be a hybrid application with some software installed on a computing device. The application 102 may be an application which exists wholly or in part on a user's computing device. The application 102 may be an internet access application, such as a browser. The application 102 may be a chromium-based browser. The application 102 may be an application which may access one or more resources over a network, such as a printer, a display, a remote computing device (for example, a smart lock, a router, a smart switch, etc.), etc.

The application 102 may include an extension, which may communicate between the application 102 and the rest of the system 100, including by controlling the application 102 based on information provided by the rest of the system 100. The extension may be specific to a native application. The extension may be downloaded by the user, the enterprise, etc. The extension may be required for the use of the application 102 on an enterprise device or with enterprise resources. The extension may be downloaded from an enterprise specific software library. In some embodiments, the extension may instead or additionally be part of the application 102-e.g., part of an initial software download or otherwise integrated such that the application 102 substantially always includes the extension or other software which communicates with the system 100. For example, the application 102 may be a software application specific to the enterprise or devices thereof.

The application 102 may default to allowing or preventing access to substantially all network resources. For example, the application 102 may prevent access to any network resource, any of one or more classes of network resources, etc. such as by blocking access (e.g., by blocking web addresses, enforcing a firewall, blocking IP addresses, etc.) unless specifically enabled to provide access. In another example, the application 102 may allow access to any network resource, any of one or more classes of network resources, etc. such as by blocking access (e.g., by blocking web addresses, enforcing a firewall, blocking IP addresses, etc.) unless specifically permitted to provide block access, such as by provision of a block list. In an extension of this example, the application 102 may, for example, be provided on a user's personal computing device, such as a mobile phone. When the user is using their personal computing device for personal use, the application 102 may allow access to substantially all external network resources (and, in some embodiments, prevent access to internal enterprise network resources). When the user is using their personal computing device for enterprise use, such as by logging in to an enterprise application that allows them access to the application 102, by VPNing into to an enterprise computer device, by clocking in to an enterprise time keeping system, etc., the application 102 may not allow substantially all external network resources (and may, in some embodiments, enable access to internal enterprise network resources). In some embodiments, the application 102 may default to allowing access to a first set of network resources (e.g., an allow list), blocking access to a second set of network resources (e.g., a block list), and conditionally allow or block other access to network resources outside the first set and second set. The conditional allowance or blockage may be determined based on an examination of the network resource itself, the user's profile, the level of permission which the user has requested, the frequency or change in frequence at which users similar to the user access the network resource, or various other procedures which will be described in more detail following.

The application 102 may store information about a given network resource in cache. The cache may be dynamic, static, temporary, etc. The system 100 may allow or block not only access to a network resource, but also or instead access to cached data associated with the network resource. For example, the application 102 may block access to a cached version of the network resource stored by the application 102 if it determines that the network resource is to be blocked. This may happen even if the user was allowed to access the network resource previously, such as during a visit which caused the associated content to be stored in cache. The application 102 may determine if the network resource is blocked or allowed every time access to the network resource is requested, including from cache or from an original source or hosting server.

For each request to access a network resource, the application 102 may request a verdict from a verdict service 110. The verdict may be that the network resource is blocked, allowed, isolated, restricted, etc., where restrictions may include restrictions on downloading (e.g., of images, of video, of macros, etc.), uploading, printing, screen capturing, inputting, copying data from, etc. The verdict may be determined based on the network resource alone (e.g., independent of user), based on the user profile (for example, a user job description or scope group), based on a user justification for user, based on a user step up request, etc. The verdict may be determined at the time the network resource interacts with cache—for example, either to be stored in cache for an initial visit or retrieved from cache for a subsequent visit. The verdict may be stored in cache. In some embodiments, the verdict may be stored in static cache, including as part of a list which may be updated periodically or semi-periodically. In some embodiments, the verdict may be stored in dynamic cache. For example, the verdict may be stored in association with images, text, etc., corresponding to the given network resource. The verdict may be accessed together with the data associated with the network resource. In some embodiments, the verdict may be checked against continuity of the network resource. For example, the verdict may be associated with a fully qualified domain name (FQDN) and if the FQDN differs from that associated with the verdict, the verdict may be rendered moot and another verdict requested for the different FQDN from the verdict service 110. In another example, the verdict may be associated with data cached for the network resource and if a subsequent visit to the network resource pulls more or different data from the original source, the verdict may be rendered moot and another verdict requested for the different FQDN from the verdict service 110 (such as may occur if a website is compromised and replaced with different data or even just updated by the host). The verdict service 110 may store the verdict, in combination with an identified (such as an FQDN) for each network resource in a verdict database 112.

The application 102 may store information about the network resources a user has requested, visited, etc. in an application log 104. The application log 104 may be stored on the user's computing device or in any other appropriate location. The application log 104 may include information about the user's identity, such as the user's profile. In some embodiments, the application log 104 may be anonymized. The application log 104 may include information about what the user has input, transmitted, uploaded, downloaded, printed, etc. from or to the network resource. In some embodiments, some parts of the application log 104 may be secured, including at different levels of security protocols. For example, the application log 104 may be accessible to other users who provide network security, but within the application log 104 information input by the user into one or more network resource, which may, for example, include user names, passwords, routing numbers, etc., may only be accessible to network security managers or with permission from multiple security administrators. The application log 104 may be stored with any appropriate security protocol, including encoding during transmission, restricted permissions, etc.

A data collector service 140 may retrieve the application log 104, including from multiple users, and synchronize, collate, accumulate, etc. the data. The data collector service 140 may retrieve the application log 104 from a user's computing device, including periodically, semi-periodically, instantaneously, etc. In some embodiments, the data collector service 140 may retrieve (or receive pushed) application logs at set intervals, each time a user requests access to a network resource, etc. The data collector service 140 may receive multiple application logs concurrently from different users.

The data collector service 140 may maintain, such as based on the application log 104, an application history database 142. The application history database 142 may contain de-identified or otherwise identify protected information from one or more application log 104. In some embodiments, the application history database 142 may contain part of or partial information from one or more application log 104. For example, the application history database 142 may contain a list of network resources which are requested, accessed, blocked, restricted, etc., but not the information input by a user into a successfully requested network resource. Such information may be stored in the application log 104, but stripped before the application log 104 data merges into the application history database 142, such as before transmission to the data collector service 140 or by the data collector service 140. Thus, such information may be stored for retrieval if needed, but the application history database 142 may contain information with lower security requirements than the application log 104.

The application 102 may also communicate with a knowledgebase service 130. The knowledgebase service 130 may maintain one or more list of network resources. These may include a block list, an allow list, a list of enterprise associated network resources, etc. The knowledgebase service 130 may maintain expiration times for one or more verdicts. The knowledgebase service 130 may maintain a list of locations for one or more verdict, such as dynamic cache, static cache, etc. The knowledgebase service 130 may request information from one or more databases, such as a network resource inventory 132, a rules inventory 134, an enterprise credentials database 136, a permissions impact database 138, etc. The knowledgebase service 130 may request information about a verdict, a verdict expiration time, a verdict storage location, a user credential (e.g., username, password, email address, etc.). The knowledgebase service 130 may be multiple knowledgebase services, such as one service for each knowledgebase. The knowledgebase service 130 may communicate with the application log 104, such as to receive (or request) information about user requests to access network resources.

A management user interface (UI) 150 may be accessible by enterprise security personnel. The management UI 150 may be configured to receive input from one or more enterprise security service, API, employee, etc. The management UI 150 may maintain one or more lists of network resources, such as a block list, allow list, restrict list, etc. The management UI 150 may enable security personnel to update network resource permissions, such as by providing or updating said lists. The management UI 150 may enable security personnel (or any other appropriate enterprise employees) to move one or more network resource from an allow list to a block list or vice versa. Likewise, the management UI 150 may enable security personnel to alter a verdict on a network resource, such as from restricted to blocked, from isolate to allow, etc. The management UI 150 may include one or more display windows or other interface (such as a portal, terminal access point, etc.) for security personnel to update lists, review lists, update verdicts, review verdicts, etc. The management UI 150 may also be used to maintain, view, etc. one or more databases, such as a permissions database 152, the network resource inventory 132, the rules inventory 134, the enterprise credentials database 136, the permissions impact database 138, etc. The management UI 150 may be one or more management interface or service that may provide access to set up, maintain, change, monitor, etc. the system 100.

The permissions database 152 may be any appropriate database which records permissions, which may be verdicts at any level, such as enterprise-wide verdicts, user group verdicts, individual verdicts, etc. Permissions may additionally or instead be, instead of lists of network resources, lists of types, categories, groups, classes, etc. of network resources which have associated block, allow, restrict, etc. actions associated with them. For example, permission for all gambling associated websites may be blocked. The permissions database 152 may list “block” in association with “gambling” or another topic and any network resource associated with gambling, such as a casino website, a sports betting website, download of a betting application, etc. may be blocked. In another example, permission for all internal network resources, such as for an internal network resource such as websites, may be allowed. The permissions database 152 may list “allow” in association with “enterprise. com” or another portion (terminal or otherwise) of a FQDN. The permissions database 152 may or may not contain individual network resources. In some embodiments, individual network resources may be added (or deleted) from the permissions database 152, such as by a user (e.g., security personnel) using the management UI 150, by the verdict service 110, by an analytics service 120, etc. The permissions database 152 may log permissions for network resources over time. For example, the permissions database 152 may log how many users access a given network resource in a given time once it is enabled. The permissions database 152 may determine a change in the number of users accessing a given network resource.

The permissions database 152 may include or be in communication with a permissions impact database 138. The permissions impact database 138 may, including instead of the permissions database 152, track the number of or a change in the number of users accessing a given network resource. The permissions impact database 138 may detect, including in conjunction with a processor or other computational device, a change in behavior due to a permission, a change in permission, etc. The permissions impact database 138 may track trends in use of network resources, including first time visits, repeat visits, use of static cache, use of dynamic cache, etc. The permissions impact database 138 may trigger one or more alerts (such as to security personnel), action (such as change in permission), or other action when a change in behavior or suspicious behavior is detected in connection with a request to access or allowed access to one or more network resources. For example, the permissions impact database 138 may determine that allowing a first user (or first group of users) to access a given network resource has resulted in an increase in the number or frequency of users requesting access to the given network resource. This may trigger, for example, an alert to security personnel to determine if the given network resource is benign (and possibly useful) such that use of the network resource is demanded in response to word-of-mouth, that the given network resource is associated with a phishing or other adversarial attack attempt and that the demand is spurred by additional users receiving emails, internal messaging, or other alerts prompting them to attempt to access a malicious network resource, etc. In some embodiments, permissions impact database 138 may also cause bulk blocking or allowing of network resource to some groups of users, such as in response to unusual enterprise activity. For example, the enterprise may detect an attempted distributed denial of service (DDOS) attack on an internal network resource (such as a website). In response to this attack detection, which may be detected by any appropriate method including those not described as part of the system 100, the permissions impact database 138 may trigger adding the internal network resource to a block list—at least temporarily—in order to protect the network resource, prevent internal user confusion, determine whether the attack is internal or external, etc. In another example, the enterprise may allow, such as during a “breakglass” event, a group of users blanket permission to access all network resource, which may include those on one or more block list (e.g., an always block list). A “breakglass” event may be an event in which security personnel or other users with elevated permissions or needs are allowed to access network resources which are substantially restricted. A “breakglass” event may be an urgent event, such as failover, re-routing of internal network traffic, urgent customer support, etc. in which users require speed and access in order to restore normal working of the enterprise. Initiation of a “breakglass” event may require permission from multiple users working in concert or other types of elevated security interlocks or protocol.

The network resource inventory 132 may be an inventory of network resources, with or without associated topics, classes, categories, verdicts, user groups, etc. The network resource inventory 132 may include commonly used or requested (e.g., used daily, used weekly, used monthly, used by 1% of enterprise users, used by 5% of enterprise users, used by 10% of enterprise users, etc.) network resources. The network resource inventory 132 may include any network resource ever used or requested by an enterprise user. The network resource inventory 132 may include network resources never used or requested, requested but never allowed, etc. network resources. The network resource inventory 132 may include a catalog of harmful or otherwise not useful network resources, including such a list obtained from a third-party network resource categorization service. The network resource inventory 132 may be maintained by periodic purging of old information, updating of current information, etc. The network resource inventory 132 may further contain information about the state of the network resource when a verdict was delivered, such as the date of the verdict, so that a comparison between the network resource as currently constituted and the network resource when the verdict was delivered may be made. For example, a website which has had completely new content provided between the verdict delivered 24 hours ago may be listed in the network resource inventory 132 as uncategorized, because the current content has not had a verdict delivered. The network resource inventory 132 may contain multiple verdicts about a network resource. For example, a job search website may be blocked for most users, but allowed for recruiting staff.

The rules inventory 134 may be a list of rules by which a verdict may be obtained. The list of rules may be rules for populating one or more list, such as an allow list, a block list, an isolate list, a restricted list, etc. The list of rules may be applied based on categories, classes, identified topics, etc. with which the network resources are associated. For example, a rule may be “block gambling websites” which may result in block verdicts being issued for any website associated with a gambling related topic, where topics may be identified in any appropriate manner, including by one or more machine learning model, from topical categorization provided by a third party, etc. The list of rules may be rules which are applied based on a user profile, including one or more groups to which a user belongs. For example, a rule may be that office support staff may access a catering website or order form, while other users may be blocked from the same catering website or order form such that they may not order food themselves. The list of rules may correspond to a user's job description, permissions, role, etc. The list of rules may be rules which are applied based on a user's identity. For example, a user may request permanent access to a web-based video feed corresponding to a daycare. If the user has a good case for requesting access, such as to monitor a minor child, the user's access to that particular network resource may be permanently (or semi-permanently, such as for a month, a year, etc.) be enabled, while other user's may remain unable to access the given network resource. In another example, a user's access to a particular website may be restricted, such as by having access permanently (or semi-permanently) blocked, including because of a given user's previous behavior. The list of rules may include enterprise level rules, which may be updated as enterprise needs change or available network resources change. The rules inventory 134 may be updated, monitored, etc. in any appropriate manner, including by access from the management UI 150.

The enterprise credentials database 136 may maintain an inventory (list, table, database, etc.) of enterprise credentials. Enterprise credentials may include any enterprise level credentials, such as usernames, passwords, emails, etc., used to access enterprise resources, including enterprise network resources. For example, enterprise credentials may include a user's email address, which may be a login on one or more internal network resource, bit locker, which may be needed to log in to one or more enterprise-associated computing device, employee number, employee badge number or RFID code, one or more user biometric measurement, etc. Enterprise credentials may include one or more user name, with or without associated password. A user may be associated with multiple credentials, including multiple credentials of the same type. In some embodiments, usernames or other logins may be saved, while passwords may not be saved in the enterprise credentials database 136. The enterprise credentials database 136 may be protected from unauthorized access, encrypted, etc. in order to prevent unauthorized access. In some embodiments, the enterprise credentials database 136 may include enterprise-level credentials, such as enterprise-associated credit card numbers, automated clearing house (ACH) numbers, account numbers, routing numbers, etc. The enterprise credentials database 136 may contain any appropriate information which the enterprise wishes to protect from entry into a network resource, e.g., entry into an external network resource but also, in some cases, entry into an internal network resource. Based on the data contained in the enterprise credentials database 136, the system 100 may detect entry of such credentials and block associated network resources, issue alerts to the user about entry of such credentials, issue alerts to security personnel about entry of such credentials, etc.

The analytics service 120 may operate upon one or more other service or database to provide verdicts to the verdict service 110, including through the verdict database 112. The analytics service 120 may also receive information from the verdict service 110, upon which, in some embodiments, the analytics service 120 may operate or update. The analytics service 120 may receive information from the network resource inventory 132, the rules inventory 134, the enterprise credentials database 136, and the permissions impact database 138, the application history database 142, and any other appropriate database (e.g., such as directly from the permissions database 152 or other databases not depicted).

In some embodiments, the verdict service 110 and the analytics service 120 may provide verdicts for different types of network resources, for network resources on different time scales, for different types of access to the same network resource (for example, for repeat access versus first time access), etc. In some embodiments, the verdict service 110 may provide a verdict, such as without consulting the analytics service 120, for a network resource for which an unexpired verdict (or other unexpired data, such as text, images, etc.) are stored in cache (e.g., static or dynamic cache) or the verdict database 112. If no verdict or no unexpired verdict is stored in cache (or, in some embodiments, the verdict database 112), the verdict service 110 may consult (e.g., request a verdict from) the analytics service 120. The analytics service 120 may then generate a verdict for the given network resource based on information from the rules inventory 134, the network resource inventory 132, the enterprise credentials database 136, the permissions impact database 138, the application history database 142, etc. The verdict determined by the analytics service 120 may then be saved in the verdict database 112 and provided to the verdict service 110 for use by the application 102.

In some embodiments, the verdict service 110 may provide a first verdict, such as without consulting the analytics service 120, for a network resource on a first time scale. The first verdict may be a temporary verdict. The first verdict may be a fast (e.g., instantaneous, near instantaneous, 1-5 seconds, etc.) verdict. The first verdict may be a verdict which is fast when compared to a second verdict, where the second verdict may be issued by the analytics service 120. The verdict service 110 may provide the first verdict when the network resource is requested and prompt the analytics service 120 to provide a second, or permanent verdict (or semi-permanent verdict), while the first verdict is enforced. For example, the analytics service 120 may operate on a slower time scale than the verdict service 110, such as if it queries various databases, including databases which may be relatively infrequently (such as on the order of minutes, hours, days, etc.) or batch updated. The application 102 may operate on the first verdict (from the verdict service 110) until the second verdict (from the analytics service 120) is provided. In some embodiments, the verdict service 110 and the analytics service 120 may operate on substantially the same time scale. Once the second verdict is provided, the application 102 may switch to operating based on the second verdict. This may include blocking a previously allowed network resource, allowing a previously blocked network resource, isolating a previously allowed network resource, restricting a previously blocked network resource, or otherwise changing the network resource's blocked, allowed, restricted, isolated, etc. status. If the first verdict and the second verdict agree, the network resource's status may not change, and a user may not notice any difference in the application 102. If the first verdict and the second verdict differ, the user may notice that the application 102 functions differently after the second verdict is received. In some embodiments, the user may be notified, such as by the application 102, that the network resource has changed in status, such as “The network resource you have requested is now restricted,” when the network resource is no longer available to eh application 102. In some embodiments, if the first verdict is more highly restricted, such as blocked, and the second verdict is more permitted, such as allowed, the user may just be provided with the network resource by the application 102 when the second verdict is received. In some embodiments, the user may be provided with a notification, such as “The network resource you have requested is now allowed” when the second verdict is received and the network resource is provided. In some embodiments, if the first verdict and the second verdict differ, this may trigger an alert, such as to security personnel, indicating a difference between the verdict service 110 and the analytics service 120. In some embodiments, once the second verdict is received from the analytics service 120, it may be saved to the verdict database 112 and replace any first verdict previously determined by the verdict service 110.

In some embodiments, the verdict service 110 may provide a verdict about different use cases than the analytics service 120. For example, the verdict service 110 may provide information to the application 102 about a website, while the analytics service 120 may provide information to the application 102 about information input into the website, downloaded from the website, printing, etc. In another example, the verdict service 110 may provide enterprise-wide verdicts, while the analytics service 120 may provide user specific verdicts, such as based on a user profile, requested access justification, etc. In yet another example, the verdict service 110 may provide information to the application 102 about internal websites, while the analytics service 120 provides information to the application 102 about external websites. In another example, the verdict service 110 may provide information to the application 102 about network resources on one or more lists, such as a block list, an allow list, a restrict list, etc., while the analytics service 120 may provide information to the application 102 about network resources which are unknown, unclassified, or not on the lists to which the verdict service 110 has access.

The analytics service 120 may determine various group level statics about network resource requests, access, behavior, etc. In some embodiments, the analytics service 120 may provide information about enterprise level use to an enterprise use database 122. The enterprise use database 122 may contain information about network resource requests and access for an entire enterprise or subset (e.g., subsidiary) of an enterprise. In some embodiments, the analytics service 120 may provide information about department level use to a department use database 124. The department use database 124 may contain information about network resource requests and access for an entire department, where department may be defined in any appropriate manner, of an enterprise. For example, accounting may be a department, New York City accounting may be a department, East Coast cost accounting may be a department, etc. In some embodiments, the analytics service 120 may provide information about neighborhood level use to a neighborhood use database 126. The neighborhood use database 126 may contain information about network resource requests and access for neighborhood, where neighborhood may be defined in any appropriate manner, of an enterprise. A neighborhood may be larger or smaller than a department. In some embodiments, neighborhoods may be subsets of a department. In some embodiments, neighborhoods may be physically based while departments are task or job-description based. For example, a neighborhood may be 124 Main Street, Albany, NY 6^{th} floor, a neighborhood may be Houston, Texas accounting administrative assistants, a neighborhood may be employees currently connected to an internal network resource over a given VPN, etc. In some embodiments, the analytics service 120 may provide information about user level use to a user use database 128. The user use database 128 may contain information about network resource requests and access for a single user or associated with a single user. The analytics service 120 may also may decisions based on the information stored in the enterprise use database 122, the department use database 124, the neighborhood use database 126, and the user use database 128, including at any appropriate level (e.g., at the enterprise level, at the department level, at the neighborhood level, at the user level, etc.). The enterprise use database 122, the department use database 124, the neighborhood use database 126, and the user use database 128 may also be used, such as by security personnel accessing the system through the management UI 150, to observe (and respond to) trends in network resource requests or access.

The system 100 may include one or more user verification interfaces (or other user verification method). The user verification may provide access, from the system 100, to the user profile, such as in the permissions database 152. The system 100 may provide different access to a generic user (e.g., a user who is not signed in or who has not verified their identify) versus a verified user. In some embodiments, a generic user may have more restricted (e.g., base) access versus a verified user. The system 100 may include one or more justification interface (or other avenue for providing justification) for explaining a business or personal need to access a given network resource. The justification interface may be an email prompt, pop up window, etc. In some embodiments, a justification may be required for access to some network resources, e.g., usually blocked network resources. In some embodiments, a justification may also be provided to block a normally allowable resource, such as for just the user, for a department, at the enterprise level, etc. The system 100 may include one or more interface configured to accept a time request for access to the network resource. The user may provide a requested time duration for access to the network resource, including concurrently with user verification, concurrently with the request to access the network resource, or at any other appropriate juncture.

The system 100 may allow real-time or close to real-time access for a user to one or more network resource. “Real-time” as used herein may include substantially real-time events, such as events occurring with no time lag or with a time lag, but a time lag which does not significantly impede enterprise function (e.g., access to a network resource within 2 seconds of a request, within 30 seconds of a request, within 2 minutes of a request etc.) Other time periods may be contemplated within the scope of this disclosure.

“Real-time” may include one or more intervening steps. That is, real-time access may include access which requires one or more intermediate steps following the request. These steps may include, without limitation, one or more steps associated with an attempt to navigate to a network resource, logging in to a user verification system, authentication, etc.

The system 100 may allow just-in-time access for a user to one or more network resources. “Just-in-time” (or JIT) may include substantially just-in-time events or provision (as of network resources) as they are needed, such as by a user, by the enterprise, etc., which may include a delay, such as to the user or the enterprise, between requesting of the access and enabling of access to the network resource. “Just-in-time” may include delivery of a network resource based on a request of the user or enterprise. For example, a pop-up window or interface for requesting a network resource may be triggered by a user action in the application 102 or another application, such as logging into a user computing device associated with the system 100. “Just-in-time” may not require that a network resource be delivered (e.g., provided to the user) automatically based on user behavior. For example, the request for the network resource may require or begin with an active request by the user—that is, by inputting a web address into the application 102 or otherwise actively requesting access such as by opening an interface for requesting the network resource. “Just-in-time” may not imply that any such delivery of a network resource excludes user identify verification, user eligibility determination, etc.

The system 100 may allow for just-enough-time access for a user to one or more network resources. “Just-enough-time” may include incremental time, which may or may not be extendable, for access to the network resource. “Just-enough-time” may not require that a network resource be enabled for as long as the user has need of it or that the necessary time duration for access be determined by the system 100. For example, the enablement of the network resource may be for a set increment. In another example, the enablement of the network resource may be provided for an increment which is determined based on a user profile, a network resource type, a justification, etc. Just-enough-time may be limited by the system to a reasonable time, such as the length of an average employee workday, business hours, etc. Just-enough-time may include the ability of the user to disable access to a network resource if the user has finished a task (e.g., step down the network resource).

The system (e.g., the system 100), the application (e.g., the application 102), and any other systems, applications, user interfaces, etc. may be used to provide access to one or more network resources, which may be a computer resource, in the manner described herein or in the manner described in U.S. patent application Ser. No. 18/174,234, titled SYSTEM AND METHODS FOR CONTROLLED ACCESS TO COMPUTER RESOURCES, filed 24 Feb. 2023, International Patent Application PCT/US 2023/076801, titled SYSTEM AND METHODS FOR CONTROLLED ACCESS TO COMPUTER RESOURCES, filed 13 Oct. 2023, and U.S. patent application Ser. No. 18/510,312, titled SYSTEM AND METHODS FOR CONTROLLED ACCESS TO COMPUTER RESOURCES, filed 15 Nov. 2023—each of which is hereby incorporated by reference—or in any appropriate combination of manners described herein and in the incorporated references.

FIG. 2 depicts an example user browser graphical user interface (GUI) 210, in accordance with some embodiments of the present disclosure. The user browser GUI 210 may be provided on any appropriate user device, such as a laptop, mobile phone, etc. The user browser GUI 210 may be provided by any appropriate application, such as the application 102 of FIG. 1. The user browser GUI 210 may be any appropriate UI.

The user browser GUI 210 may be a UI which corresponds to the application used to access a network resource. In some embodiments, the user browser GUI 210 may instead or additionally be any appropriate UI used to interface with the system for controlling access to network resources (such as the system 100 of FIG. 1), such as UI configured to accept an IP address, a printer UI, etc. In some embodiments, the user browser GUI 210 may display an indication, such as an icon, a logo, etc. that indicates that it is compatible with the system for controlling access to network resources. In some embodiments, the user browser GUI 210 may correspond to a browser with an extension, the extension configured to communicate between the browser and the system for controlling access to network resources. In some embodiments, the user browser GUI 210 may indicate that such an extension is installed. In some embodiments, the user browser GUI 210 may include, such as part of the native application, as part of a hybrid application, as part of a web application, etc., programming configured to communicate with the system for controlling access to network resources, without any system-specific extension. The user browser GUI 210 may be for a chromium-based browser, or any other appropriate type of browser. The user browser GUI 210 may include a display region for a website 220, which may include image content 222 (e.g., static images, JPEG, GIFs, etc.), animated content 224 (e.g., moving images, videos, etc.), text content 226, which may be text images or instructions configured to render text, link content 228, which may be any content which includes a hyperlink or other link content, whether such link be to another website, a macro, a program, an API, etc., and audio content 230. The website 220 may also or instead contain any other appropriate website content, including internal or external content. The system for controlling access to network resources may treat different types of content, including content of the same type which is stored differently, in different manners. For example, the system for controlling access to network resources may automatically disable audio content 230 or automatically disable audio content 230 unless headphones are selected as the audio provision method. In another example, the system for controlling access to network resources may automatically enable text content 226, but automatically disable link content 228 for external network resources (e.g., websites). In some embodiments, different types of content may be stored in (or retrieved from) different types of cache, where the type of cache used to store the content may control how the content is treated by the system for controlling access to network resources.

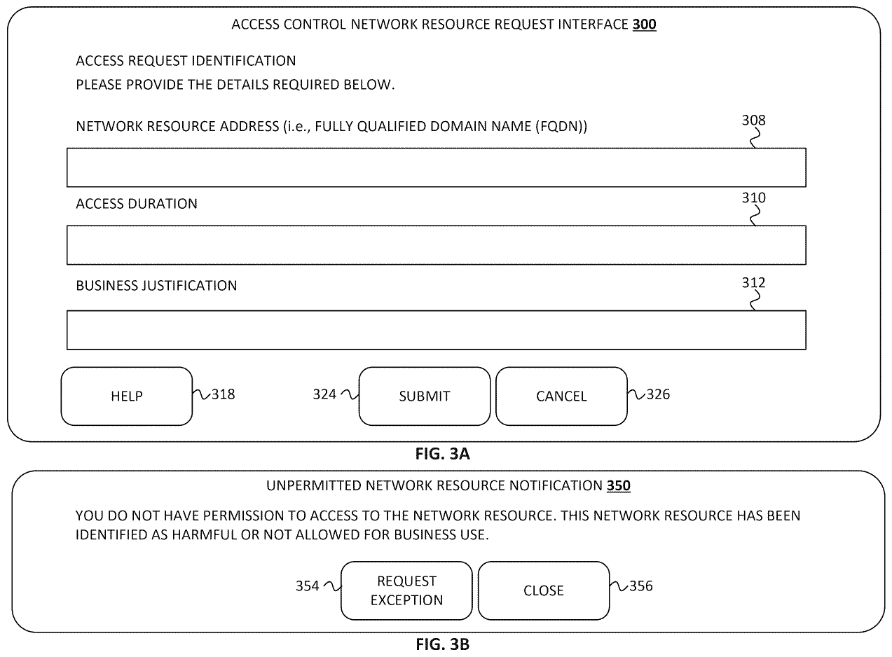

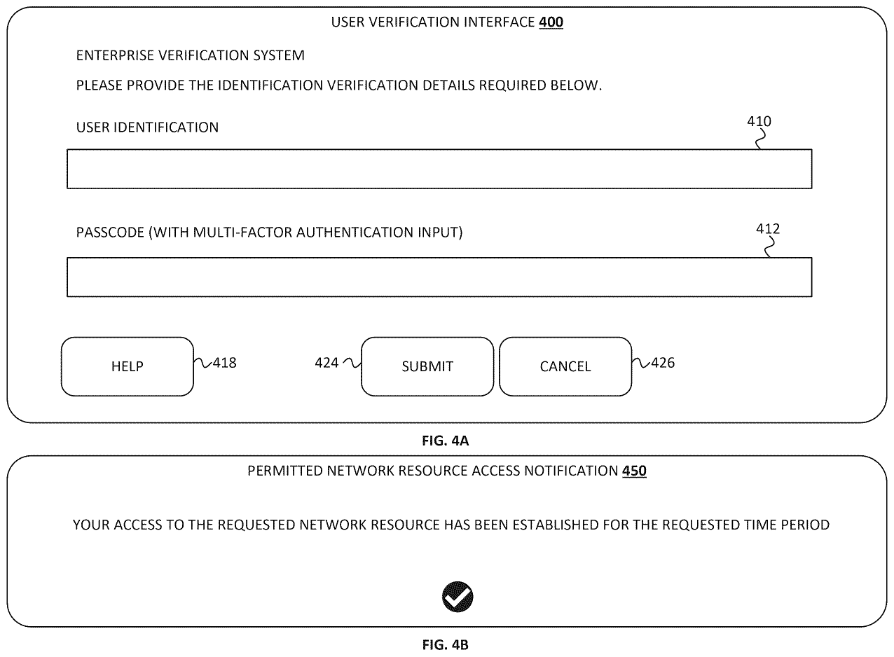

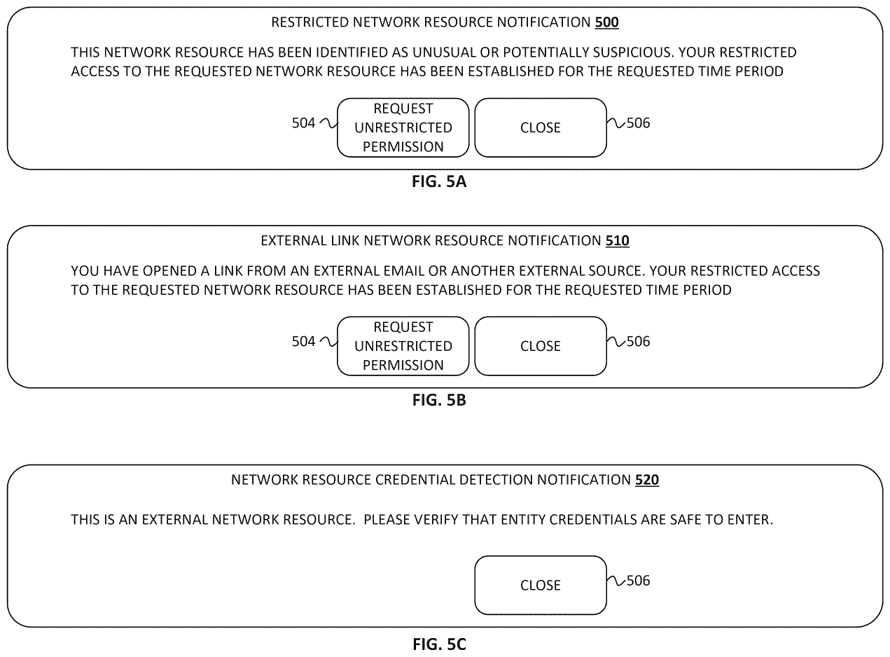

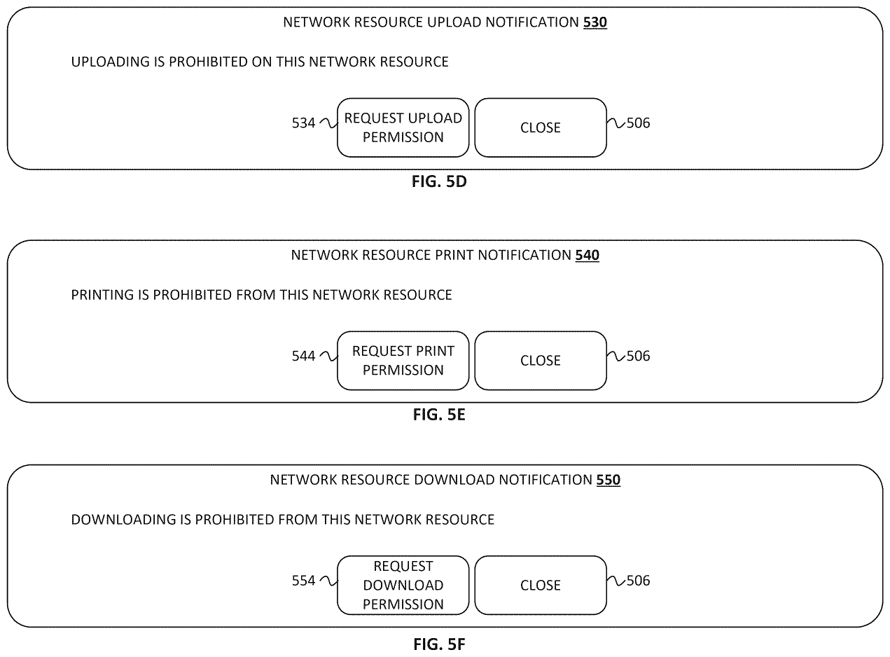

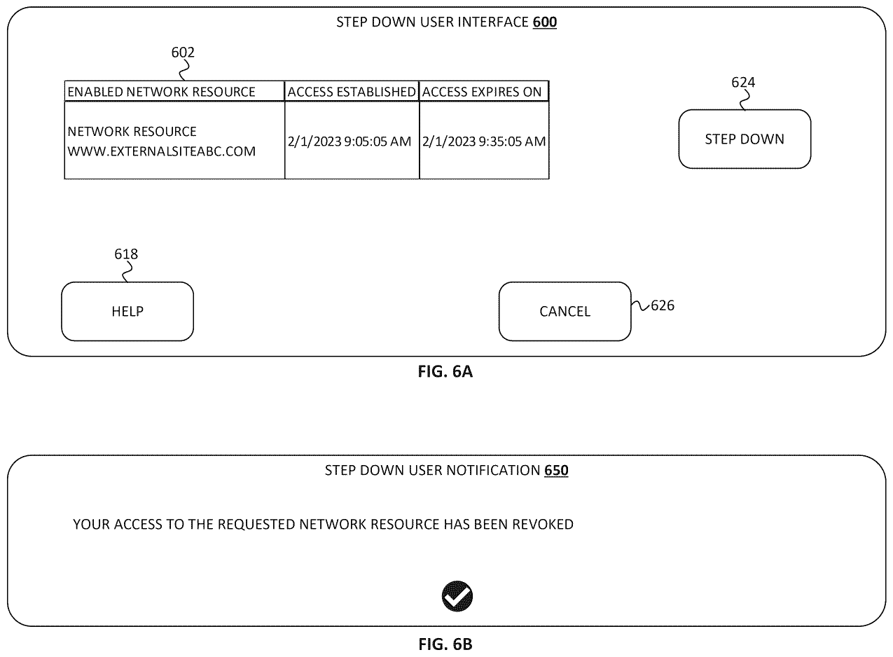

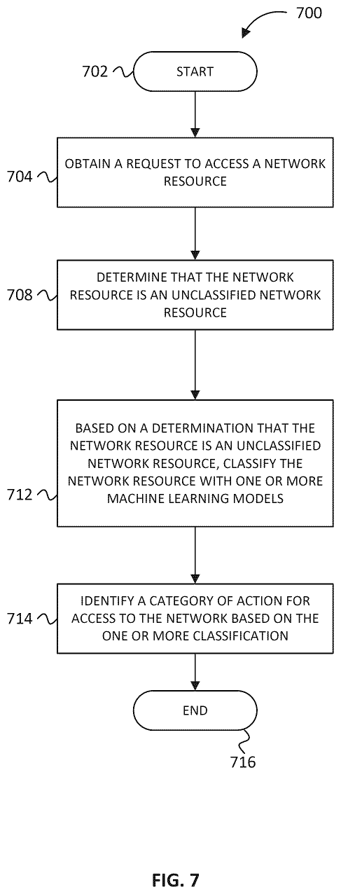

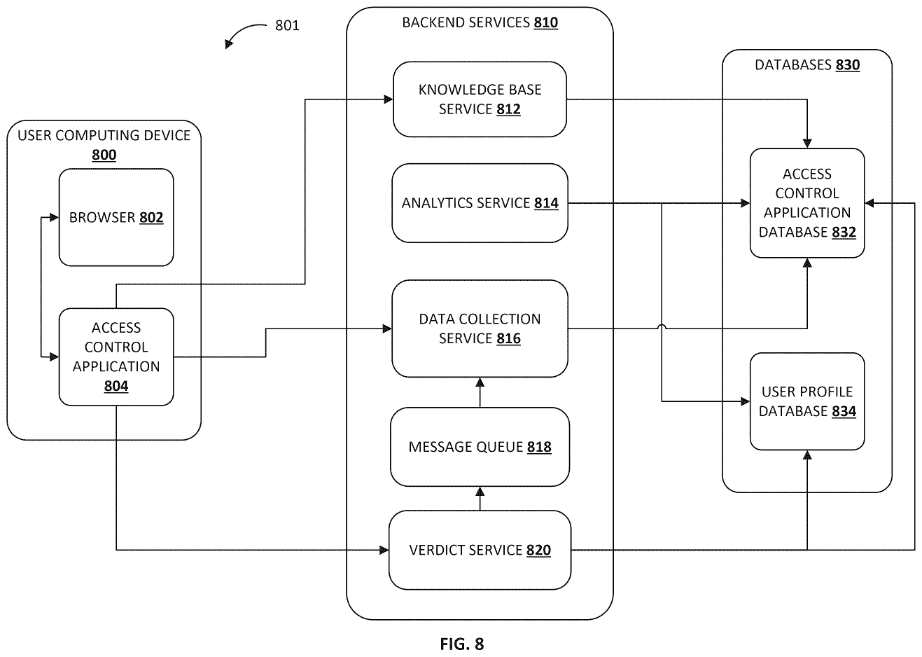

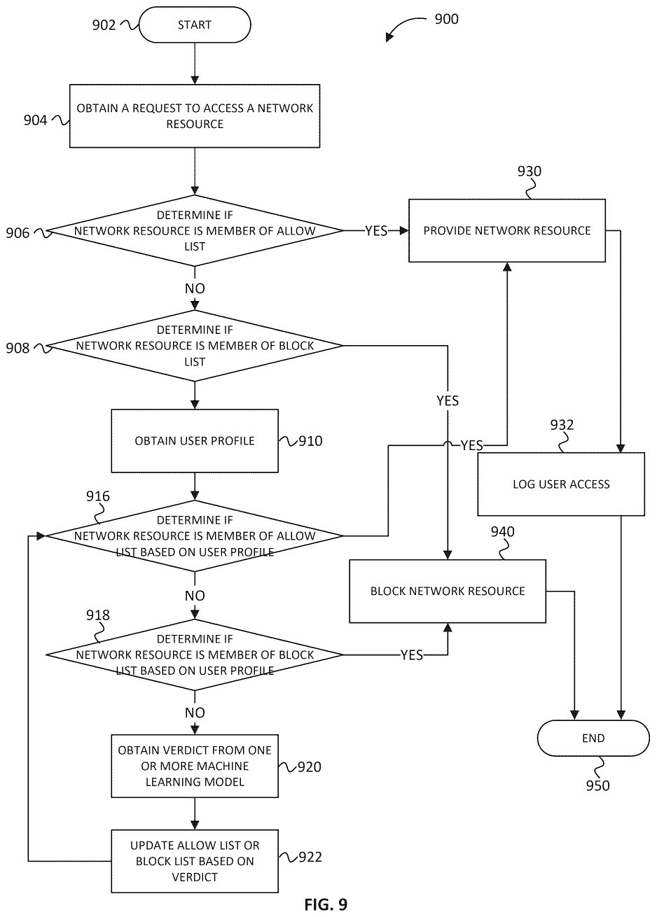

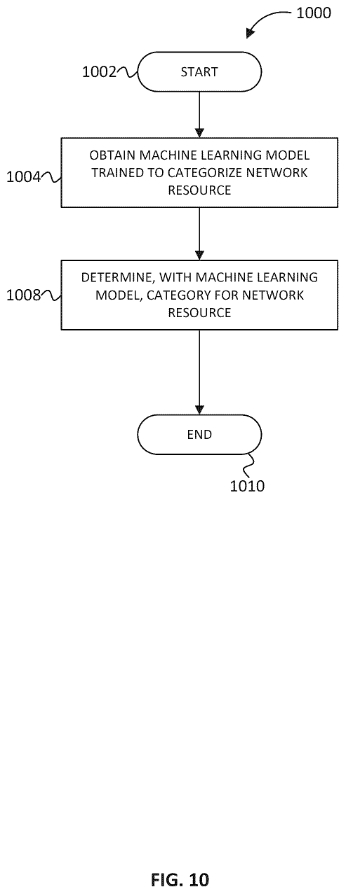

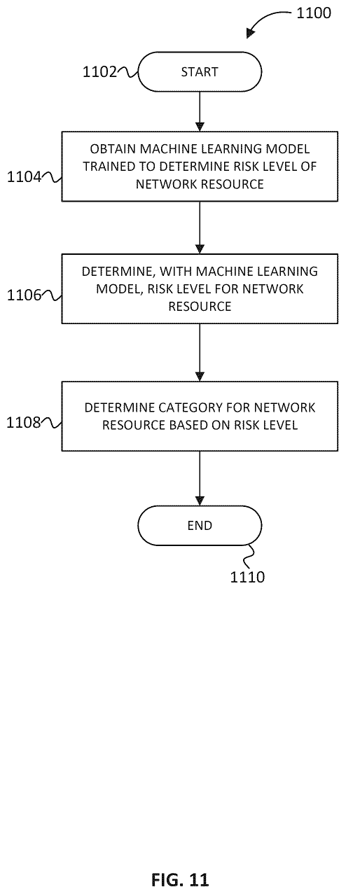

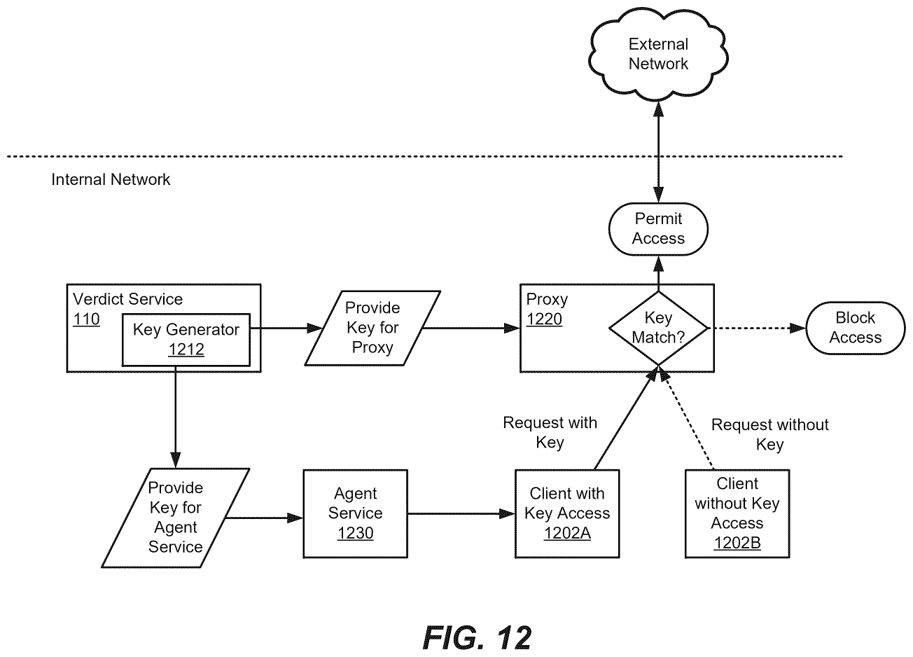

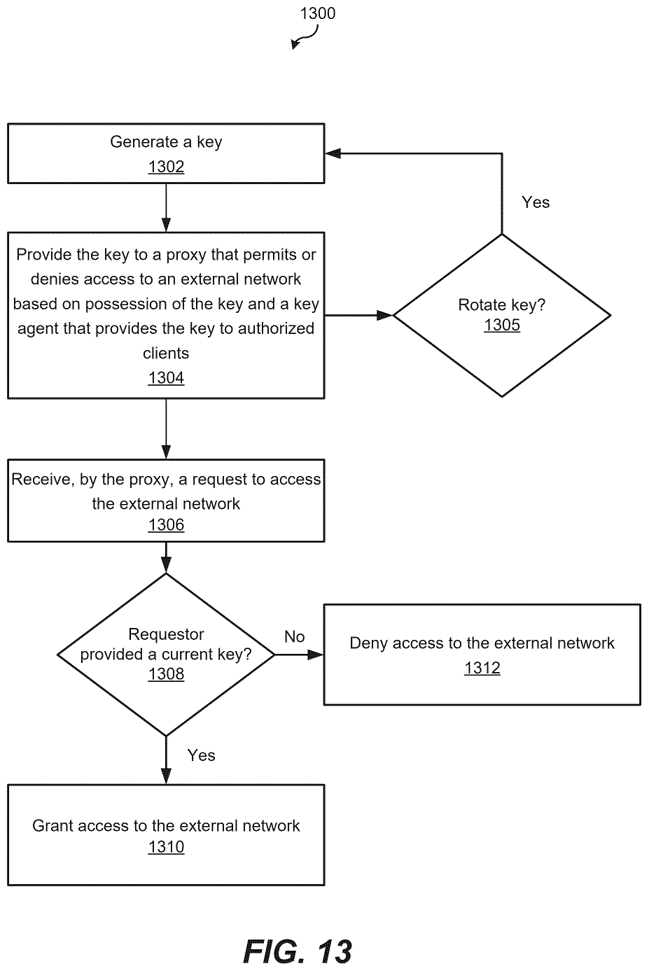

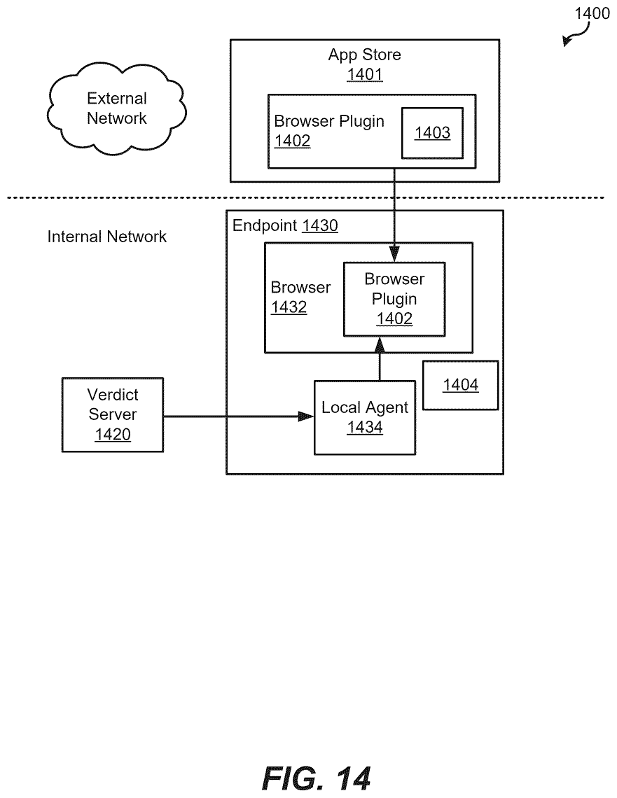

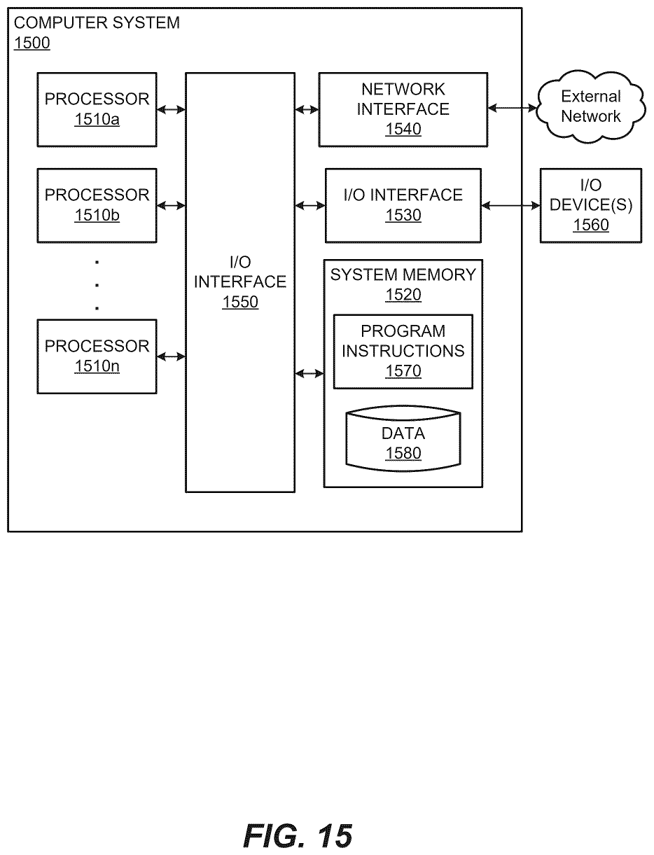

FIG. 3A depicts an example user interface for a network resource request (e.g., a request interface 300), in accordance with some embodiments of the present disclosure.

The request interface 300 may include one or more input region configured to identify or receive information about which network resource is being requested (such as typed by the user, filed out in response to the user following a hyperlink, etc.), such as text box 308, drop down menu, or other input element for network resource address. The request interface 300 may include a text box 310, drop down menu, or other input element, which may allow a user to select a time duration for requested access to the network resource. The options may be time intervals, such as 30 minutes, 1 hour, several hours, etc., which may vary depending on the network resource or network resource type, such as for an internal network resource versus an external network resource. The time intervals may be designed to accommodate an average task which may be performed by a user with the network resource.

The request interface 300 may include a text box 312, drop down menu, or other input element, which may allow (or require) the user to input a reason (e.g., business justification), as a text string, free text, select from prepared responses, etc. that explains why the user requested access to the network resource. The user may or may not be required to submit a reason before access will be granted. The request interface 300 may include a link or other option for help 318 or explanations of the various options for a user. The request interface 300 may include a link or other option to submit 324 the request for the network resource. The request interface 300 may include a link or other option to cancel 326 the request for the network resource. Any information input into the request interface 300 may be stored, such as in an application log 104 of FIG. 1 for subsequent reference, analysis, etc. The information input into the request interface 300 may be used to deliver a verdict on the allowability of access to the network resource, such as by the verdict service 110 or the analytics service 120 of FIG. 1.

FIG. 3B depicts an example network resource request denial notification 350, in accordance with some embodiments of the present disclosure. A user who is not permitted access for a given network resource may receive the network resource request denial notification 350. The network resource request denial notification 350 may be generated by the system for controlling access to network resources, such as by the system 100 of FIG. 1. In some embodiments, a network resource request denial notification 350 may be displayed to a user instead of the request interface 300 of FIG. 3A, such as if the user is not logged in, not verified, etc. The network resource request denial notification 350 may include a link or other option to request an exception 354, such as from the enterprise, from security personnel, by re-requesting an access verdict, etc. network resource request denial notification 350 may include a link or other option to close 356 the notification. An explanation of the reason the computer resource is not permitted may also be provided.

FIG. 4A depicts an example user interface for user verification (e.g., user verification interface 400), in accordance with some embodiments of the present disclosure. The user verification interface 400 may be part of the system for controlling access to network resources (e.g., the system 100 of FIG. 1) or may be in communication with the system for controlling access to network resources. In some embodiments, the user verification interface 400 may be part of, including a pop up automatically generated by, a browser (such as the user browser GUI 200 of FIG. 2) or another appropriate access application (e.g. the application 102 of FIG. 1). In some embodiments, the user verification interface 400 may be part of a log in or other access request system, such as a log in required to access the user's computing device or another enterprise-associated computing device. For example, the user verification interface 400 may be part of an authentication system, a multi-factor authentication system, or any other appropriate authentication (e.g., verification) system. The user verification interface 400 may include a text box 410, drop down menu, or other input element, which may allow a user to provide a user identification, such as a user ID, employee number, etc. The user verification interface 400 may include a text box 412, drop down menu, or other input element, which may allow a user or other service or operator to provide a second (or other multi) factor for user verification. The text box 412 may instead or additionally be another type of authentication, including another type of input such as biometric scanner, microphone for voice recognition, etc. The factor for user verification may be a passcode (such as a pin and a token), which may uniquely identify the user at an instance in time. The passcode may include a code specific to the user and a random or pseudo-random element, such as an alphanumeric code. The passcode may be obtained from another device, such as from a random number generator, text message service, etc. which may be possessed by or in communication with the user. The user verification interface 400 may be provided by a user verification service or system which interfaces with the access control system. The user verification interface 400 may include a link or other option for help 418 or explanations of the various options for a user. The user verification interface 400 may include a link or other option to submit 424 the request for user verification. The user verification interface 400 may include a link or other option to cancel 426 the request for the computer resource.

FIG. 4B depicts an example network resource allowance notification 450, in accordance with some embodiments of the present disclosure. Once a user verification is complete and a verdict is returned (such as by the system 100 of FIG. 1) that the requested network resource is allowable, a notification may be displayed to the user indicating that the requested computer resource is available for access. The network resource allowance notification 450 may include a time duration for access, an end time when access will be revoked, etc. Once access to the computer resource is approved, a user interface may be displayed or updated to reflect the current status of the computer resource.

FIGS. 5A-5F depict various example network resource notifications, in accordance with some embodiments of the present disclosure. FIG. 5A depicts an example restricted network resource notification 500, in accordance with some embodiments of the present disclosure. If the system for controlling access to network resources determined that a user (or multiple users, up to and including all users) in not permitted access to a given network resource, the restricted network resource notification 500 may be displayed. The restricted network resource notification 500 may include a link or other option for help or explanations of the various options for a user. The restricted network resource notification 500 may include a link 504 or other option to request unrestricted access to the given network resources. The link 504 may cause an alert to be sent to security personnel, the system for controlling access to network resources (e.g. the system 100 of FIG. 1), or any other appropriate personnel, system, database, etc., for re-consideration. The restricted network resource notification 500 may include a link or other option to close 506 the restricted network resource notification 500.

FIG. 5B depicts an example external link network resource notification 510, in accordance with some embodiments. If the system for controlling access to network resources determined that a user (or multiple users, up to an including all users) has requested a network resource based on selection of an external link, such as an external link from an email, from a previous network resource (e.g., website) location, etc., the user may be notified that the network resource is from an external link. In some embodiments, the external link network resource notification 510 may include text to prompt the user to consider the security of such a link. In some embodiments, detection of a request to access a network resource from an external link may be tracked, such as in the application log 104 of FIG. 1, including separately from or in addition to other requests which do not correspond to external links. In some embodiments, external links may be considered to have higher likelihood of representing security risks, such as due to phishing or other malicious activity. The external link network resource notification 510 may include a link or other option for help or explanations of the various options for a user. The external link network resource notification 510 may include a link 504 or other option to request unrestricted access to the given network resource. The link 504 may cause an alert to be sent to security personnel, the system for controlling access to network resources (e.g. the system 100 of FIG. 1), or any other appropriate personnel, system, database, etc., for re-consideration or consideration of the network resource corresponding to the external link. The link 504 may cause evaluation of the network resource corresponding to the external link, such as by the system 100 of the FIG. 1, such as once the user has acknowledged that the network resource corresponds to an external link. The external link network resource notification 510 may include a link or other option to close 506 the external link network resource notification 510.

FIG. 5C depicts an example credential detection notification 520, in accordance with some embodiments. If the system for controlling access to network resources determines that a user has input one or more credentials (such as recorded in the enterprise credentials database 136 of FIG. 1) into a network resource, the user may be notified. The system for controlling access to network resources (such as the system 100 of FIG. 1) may be configured to detect any inputting of enterprise credentials into a network resource. In some embodiments, if credentials are detected, the credential detection notification 520 may notify the user that such credentials are detected. In some embodiments, the credential detection notification 520 may include text to prompt the user to consider the security inputting the detected credentials. In some embodiments, inputting of enterprise credentials may be tracked, such as in the application log 104 of FIG. 1, including separately from or in addition to other input or requests for network resources. In some embodiments, inputting of enterprise credentials into internal network resources (such as internal enterprise websites) may not be tracked or not trigger a credential detection notification 520. In some embodiments, external network resources to which one or more users input enterprise credentials may be tracked, such as by inclusion in a database such as the network resource inventory 132 of FIG. 1. In some embodiments, some network resources which request enterprise credentials, such as external websites authorized by the enterprise which may use, for example, an enterprise email address as a log in, may not be tracked or not trigger a credential detection notification 520. In some embodiments, tracking of a network resource to which one or more users has entered enterprise credentials may include tracking of each instance of a user inputting enterprise credentials. The credential detection notification 520 may include a link 524 may include a link or other option to close 506 (or acknowledge) the credential detection notification 520.

FIG. 5D depicts an example upload notification 530, in accordance with some embodiments. If the system for controlling access to network resources determines that a network resource is to be restricted (that is, access is allowed in some respects and blocked in some respects), the user may be notified. In some embodiments, if the system for controlling access to the network resource determines that upload is to be blocked for a given network resource, such as based on a verdict of the verdict service 110 or the analytics service 120 of FIG. 1, then the upload notification 530 may be displayed to the user. The upload notification 530 may include a link or other option for help or explanations of the various options for a user. The upload notification 530 may include a link 534 or other option to request upload permission to the given network resource. The link 534 may cause an alert to be sent to security personnel, the system for controlling access to network resources (e.g. the system 100 of FIG. 1), or any other appropriate personnel, system, database, etc., for re-consideration or consideration of uploading to the network resource. The upload notification 530 may include a link or other option to close 506 the upload notification 530.

FIG. 5E depicts an example print notification 540, in accordance with some embodiments. In some embodiments, if the system for controlling access to the network resource determines that printing is to be blocked for a given network resource, such as based on a verdict of the verdict service 110 or the analytics service 120 of FIG. 1, then the print notification 540 may be displayed to the user. The print notification 540 may include a link or other option for help or explanations of the various options for a user. The print notification 540 may include a link 544 or other option to request print permission to the given network resource. The link 544 may cause an alert to be sent to security personnel, the system for controlling access to network resources (e.g. the system 100 of FIG. 1), or any other appropriate personnel, system, database, etc., for re-consideration or consideration of printing of the network resource. The print notification 540 may include a link or other option to close 506 the print notification 540.

FIG. 5F depicts an example download notification 550, in accordance with some embodiments. In some embodiments, if the system for controlling access to the network resource determines that downloading is to be blocked for a given network resource, such as based on a verdict of the verdict service 110 or the analytics service 120 of FIG. 1, then the download notification 550 may be displayed to the user. The download notification 550 may include a link or other option for help or explanations of the various options for a user. The download notification 550 may include a link 554 or other option to request download permission to the given network resource. The link 554 may cause an alert to be sent to security personnel, the system for controlling access to network resources (e.g. the system 100 of FIG. 1), or any other appropriate personnel, system, database, etc., for re-consideration or consideration of downloading of one or more file, image, etc., associate with the network resource. The download notification 550 may include a link or other option to close 506 the download notification 550.

FIGS. 6A-6B depict an example user interface and alert, respectively, for step down of access to a network resource, in accordance with some embodiments of the present disclosure. FIG. 6A depicts a schematic view of a step-down user interface 600. The step-down user interface 600 may allow a user to revoke access to a network resource or otherwise step down access to a network resource to which they are entitled, have previously requested, etc. before the expiration of such access. The user may select a link to step down, such as from the user browser GUI 200 of FIG. 2, which may cause the step-down user interface 600 to be displayed. The step-down user interface 600 may display a chart 602 or other visual or text representation of one or more network resources which is accessible or for which permission has currently been requested and allowed in at least some capacity. For each network resource which is currently accessible as a result of the action of the system for controlling access to network resources (e.g., the system 100 of FIG. 1), a step down 624 link or other indicator may be provided. A user may select the step down 624 link to step down a given network resource. The step-down user interface 600 may include a link or other option for help 618 or explanations of the various options for a user. The step-down user interface 600 may include a link or other option to cancel 626 the request to step down one or more network resources. Once a network resource has been successfully stepped down, such as by an action of the user in the step-down user interface 600, a notification may be displayed to the user.

FIG. 6B depicts a schematic view of an example step-down user notification 650. Once a user-initiated step down is complete (or a timer-based step down in complete), a notification may be displayed to the user indicating that the network resource is stepped down or that the step down request has been completed. The step-down user notification 650 may include an indication of which network resource access has been stepped down for, a link to request access to the network resource (such as, for example, if the step down request was made in error or the user has reconsidered their need for the network resource), etc.

FIG. 7 is a flow chart illustrating an example method for controlling access to a network resources, in accordance with some embodiments of the present disclosure. FIG. 7 depicts example operations for a method 700. At block 702, in some embodiments, a system for controlling access to network resources may be triggered. The system may be triggered by startup of a user computing device, by logging in of the user, by opening of an application, such as a browser or other appropriate network access application, by navigation to a network resource, by accessing of a network resource or associated data, such as from cache or other storage, etc.

At block 704, in some embodiments, a request to access a network resource is obtained. The request to access the network may be any appropriate request, such as a request obtained through a user browser GUI (e.g., the user browser GUI 200 of FIG. 2), through a network resource request interface (e.g., the request interface 300 of FIG. 3A), etc. The user interface may receive a request for access to the network resource. The user interface may receive, such as in the request or as part of the request, information about the user (e.g., a user identifier), information about the network resource requested, information about the time duration of the request, etc.

At block 706, it may be determined that the network resource is an unclassified network resource. An unclassified network resource may be any network resource for which a verdict is not currently extant. That is, a network resource for which a verdict as to whether to allow, block, restrict, isolate, etc. the network resource has not been issued or saved or is expired. In some embodiments, an unclassified network resource may be a network resource for which a verdict service (such as the verdict service 110 of FIG. 1) or an analytic service (such as the analytics service 120 of FIG. 1) has not delivered a verdict. In some embodiments, an unclassified network resource may be a network which does not appear on a list of classified network resources, such as a block list, an allow list, a restricted list, etc. In some embodiments, an unclassified network resource may be a network resource with is new to the system for controlling access to network resources (e.g., the system 100 of FIG. 1) or any other appropriate system for access control. In some embodiments, an unclassified network resource may be a network resource that is classified in some way, such as by topic, as internal versus external, etc., but is not classified as allowed, blocked, restricted, etc. In some embodiments, an unclassified network resource may be a previously classified network resource, including one whose classification has expired. It may be determined that the network resource is unclassified by any appropriate method, such as those described previously.

At block 708, based on a determination that the network resource is an unclassified network resource, the network resource is classified with one or more machine learning models. In some embodiments, the one or more machine learning model may categorize a type, topic, etc. of the network resource. For example, a machine learning model may identify the unclassified network resource as an employment search website, with topics such as “jobs”, “employees”, “job search”, etc. and a type “external website”. In some embodiments, based on the categorization, the network may be classified by application of a verdict, such as allow, restrict, block, isolate, etc. In some embodiments, one or more machine learning model may categorize or classify a network resource and additionally provide a level of confidence, certainty interval, etc. For example, a network resource may be associated 80% with a topic “sports betting”, or 20% with a topic “proofreading web app”. The level of confidence may be considered when classifying the network resource, such as higher confidence that a network resource is harmful may weigh a classification towards blocking, while lower confidence that a network resource is benign may also weigh a classification towards blocking, restricting, or isolating. In some embodiments, levels of confidence (e.g., confidence scores) may be derived by using term frequency-inverse document frequency (TF-IDF) to model the importance of terms used in or by the network resource and by cosine similarity (or any other appropriate similarity term, with or without embedding) to measure the similarity between feature vector(s) of the network resource and feature vector(s) associated with topic profiles (which may be predefined topic profiles). A machine learning model may be a topic model or any other appropriate model that may analyze content of a network resource and infer what topic or other category the network resource belongs to. A machine learning model may operate on Latent Dirichlet Allocation (LDA) or any other appropriate topic modeling technique. In some embodiments, a machine learning model may be trained on a set of classified (such as previously classified) network resources. In some embodiments, a machine learning model may operate on text associated with the unclassified network resource. This may include reading at least a portion of text at the network resource, tokenization of the text, text ingestion, etc. In some embodiments, a machine learning model may operate on images, video, audio, or other substantially non-textual data associated with the network resource. In some embodiments, a text-based model may be used in conjunction with a non-text-based model, including concurrently, in a decision tree, etc. in order to classify an unclassified network resource. In some embodiments, a machine learning model may output multiple classifications for an unclassified network resource—including weighted classification, different classifications for different users or different types of users, etc. In some embodiments, a machine learning model may output a multi-level classification.

At block 710, a category of action for access to the network resource is identified based on the classification. In some embodiments, access may be provided on a sliding scale, from full unrestricted access (e.g., allowance) to full restriction (e.g., blockage). In some embodiments, some network resources may be partially blocked, such as by blocking of one or more of printing, downloading, uploading, audio playing, screenshotting, etc. In some embodiments, some network resources may be isolated. Isolation may include the presenting of images, text, etc. associated with the network resource without enabling active communication (e.g., inputting, downloading, etc.) of additional content, following of links, etc. Isolation may be a permanent or temporary level of access provision. For example, in some embodiments, a network resource may be isolated before a verdict is returned. In another example, a network resource belonging to a competitor of the enterprise may be isolate—that is, available to view but not available to communicate with or through. A category for action (e.g., network resource provision) may be any appropriate category, including those previously described.

FIG. 8 is a schematic diagram depicting an example browser extension system 801, in accordance with some embodiments of the present disclosure. The system 801 may operate with the system for controlling access to network resources (e.g., the system 100 of FIG. 1). In some embodiments, the system 801 of FIG. 8 and the system 100 of FIG. 1 are the same, where the system 801 is depicted in relationship to the location of various service, databases, etc. also depicted in FIG. 1. That is, the use of the system 801 is compatible with the system 100. In some embodiments, the system 801 may be used instead of or in addition to the system 100 of FIG. 1.

The system 801 operates on a user computing device 800, on which operate a browser 802 with an extension corresponding to the access control application 804. In some embodiments, the access control application 804 may be integrated into the browser (or other network resource application) without being an extension, such as previously described. The browser 802 and the access control application 804 of the extension are in communication. In order to provide a network resource, such as a website, to a user, the browser 802 determines an access level based on information from the access control application 804 via the extension.

The access control application 804 determines an access level for a given network resource based on communication with one or more backend services 810. The backend services 810 may include a knowledgebase service 812, which may be any appropriate knowledgebase service, such as the knowledgebase service 130 of FIG. 1. The backend services may include a data collection service 816, which may be any appropriate data collection service such as the data collector service 140 of FIG. 1. The backend services may include a verdict service 820, which may be any appropriate verdict service, such as the verdict service 110 of FIG. 1. The backed service may include an analytics service 814, which may be any appropriate analytics service, such as the analytics service 120 of FIG. 1. One or more message queue 818 may provide communication, including asynchronous communication, between one or more of the backend services 810. The backend services 810 may be hosted by one or more database, server, processor, memory, etc. which is external to the user computing device 800 but internal to the enterprise network. The user computing device 800 may communicate with the backend services 810 by any appropriate method, including wired, wireless, etc.

One or more of the backend services 810 may operate upon data stored in one or more databases 830. The databases 830 may include an access control application database 832, which may contain rules, network resource inventories, application logs, browser history, etc. The databases 830 may include a user profile database 834. The databases may also or instead include any appropriate databases, including those previously described, such as the inventories and databases of FIG. 1. The databases 830 may be stored partially or fully on the user computing device 800. In some embodiments, the databases 830 may be internal network resources, such as stored at an enterprise, location, department, etc. wide level.

FIG. 9 is a flowchart illustrating a method 900 for providing access to network resources, in accordance with some embodiments of the present disclosure. FIG. 9 depicts example operations for a method 900. At block 902, in some embodiments, a system for controlling access to network resources may be triggered. The system may be triggered by any appropriate method, such as those previously described in relation to block 702 of FIG. 7.

At block 904, in some embodiments, a request to access a network resource is obtained. The request to access the network resource may be obtained in any appropriate manner, such as those previously described in relation to block 704 of FIG. 7.

At block 906, in some embodiments, it may be determined if the requested network resource is a member of an allow list. It may be determined if the network resource is a member of an allow list by any appropriate manner, such as by consultation with a verdict service (for example, the verdict service 110 of FIG. 1), a permissions database (such as the permissions database 152 of FIG. 1.), based on output of one or more machine learning models, etc. If the requested network resource is a member of an allow list, the network resource may be provided at block 930.

At block 908, in some embodiments, it may be determined if the requested network resource is a member of a block list. In some embodiments, a block list may further comprise a restricted list, an isolate list, a partial block list (e.g., a list which blocks one or more of printing, downloading, uploading, etc.). It may be determined if the network resource is a member of an allow list by any appropriate manner, such as by consultation with a verdict service (for example, the verdict service 110 of FIG. 1), a permissions database (such as the permissions database 152 of FIG. 1.), based on output of one or more machine learning models, etc. Although block 906 is depicted before block 908, these operations may occur in the opposite order, concurrently, etc. If the requested network resource is a member of a block list, the network resource may be blocked at block 940.

At block 910, in some embodiments, a user profile is obtained. The user profile may be obtained from any appropriate database, such as the permissions database 152 of FIG. 1, the user profile database 834 of FIG. 8, etc. The user profile may be obtained in response to a user verification, such as initiated by a user verification interface 400 of FIG. 4A. The user profile is depicted as obtained at block 910, but may be obtained at any appropriate juncture.

At block 916, in some embodiments, it may be determined if, based on the user profile, the requested network resource is a member of an allow list. It may be determined if the network resource is a member of an allow list by any appropriate manner, such as by consultation with a verdict service (for example, the verdict service 110 of FIG. 1), a permissions database (such as the permissions database 152 of FIG. 1.), based on output of one or more machine learning models, etc. If the requested network resource is a member of an allow list based on the user profile, the network resource may be provided at block 930.

At block 918, in some embodiments, it may be determined if, based on the user profile, the requested network resource is a member of a block list. In some embodiments, a block list may further comprise a restricted list, an isolate list, a partial block list (e.g., a list which blocks one or more of printing, downloading, uploading, etc.). It may be determined if the network resource is a member of an allow list by any appropriate manner, such as by consultation with a verdict service (for example, the verdict service 110 of FIG. 1), a permissions database (such as the permissions database 152 of FIG. 1.), based on output of one or more machine learning models, etc. Although block 916 is depicted before block 918, these operations may occur in the opposite order, concurrently, etc. If the requested network resource is a member of a block list based on the user profile, the network resource may be blocked at block 940.

Although blocks 916 and 918 are depicted separately from blocks 906 and 908, in some embodiments, a network resource may be evaluated as blocked or allowed (e.g., a member of an allow list or block list) only based on a user profile. In some embodiments, some network resources may be evaluated without recourse to a user profile while other network resources may only be evaluated based on information from a user profile.

At block 920, in some embodiments, a verdict from one or more machine learning model may be obtained for the network resource. The machine learning model may be any appropriate machine learning model, such as those described in relation to block 712 of FIG. 7. The machine learning model may classify the network resource as belonging to a block list or allow list. The machine learning model may classify the network resource as pertaining to a topic, where the topic may be one associated with a block list or allow list. The machine learning model may output any appropriate classification, including a binary classification, multi-class classification, classification with confidence interval, etc.

At block 930, in some embodiments, the allow list or block list may be updated based on the verdict obtained from the machine learning model. The allow list or block list may be updated in any appropriate manner. The allow list or block list for all users or some subset thereof (e.g., for a single user) may be updated. Once the allow list or block list is updated, flow may continue to block 916 where the network resource may be compared against the allow list or block list.

At block 932, in some embodiments, the user access may be logged. The user access may be logged in any appropriate manner, such as in the application log 104 of FIG. 1. The logging may include logging of input to, downloads from, or any other input or output material with respect to the network resource. Although block 932 is depicted as occurring after block 930, it may also occur (that is, logging may also occur) after block 940 corresponding to blocking of the network resource.

FIG. 10 is a flowchart illustrating a method for classifying a network resource, in accordance with some embodiments of the present disclosure. FIG. 10 depicts example operations for a method 1000. At block 1004, in some embodiments, a categorization of a network resource may be triggered. The categorization may be triggered by any appropriate event, including by a determination, such as by a system for controlling access to network resources, that a network resource is unclassified.

At block 1004, in some embodiments, a machine learning model trained to categorize a network resource by topic is obtained. The machine learning model may be obtained from any appropriate storage, memory, etc. The machine learning model may be previously trained, partially trained, etc. The machine learning model may operate on LDA. The machine learning model may be trained to categorize one or more type of network resource. The machine learning model may be an ensemble model.

At block 1008, in some embodiments, a category for the network resource may be determined, based on the obtained machine learning model. The category may be used to determine a classification of the network resource, a category of action to take with respect to provisioning of the network resource, etc.

FIG. 11 is a flowchart illustrating a method for determining a risk level for a network resource, in accordance with some embodiments of the present disclosure. FIG. 11 depicts example operations for a method 1100. At block 1102, in some embodiments, a risk level determination for a network resource may be triggered. The determination may be triggered by any appropriate event, including by a determination, such as by a system for controlling access to network resources, that a network resource has been requested, is unclassified, recently classified, that a previous determination has expired, that usage of the network resource has changed, etc.

At block 1104, in some embodiments, a machine learning model trained to determine a risk level for a network resource is obtained. The machine learning model may be obtained from any appropriate storage, memory, etc. The machine learning model may be previously trained, partially trained, etc. The machine learning model may be a decision tree model. The machine learning model may be a set of rules. The machine learning model may be an ensemble model. The machine learning model may be trained to output a risk level for a network resource, such as a multi-level risk classification (e.g., zero risk through high risk with any appropriate gradations). In some embodiments, the machine learning model may be trained to output a verdict, including with or instead of a risk level. For example, the machine learning model may output a category (such as of action, for provision, etc.) for the network resource, including allow, block, isolate, restrict, etc. The machine learning model trained to determine the risk level for a network resource may operate based on a machine learning model trained to classify a network resource, such as the machine learning model described in relation to FIG. 10. In some embodiments, the machine learning model trained to determine the risk level for the network resource may operate based on the classification, e.g., by topic, of the network resource as output by the machine learning model trained to classify the network resource. The machine learning model may operate on LDA. In some embodiments, the machine learning model trained to determine the risk level for a network resource may take as input risk attributes for the network resource provided by a third-party service, which may be any appropriate third-party service, such as a cloud-based service, a firewall provider, a secure web gateway provider, a DNS-layer security provider, a cloud access security broker (CASB), a threat intelligence solution, etc. The risk attributes may include age of the network resource (for example, version number, release number, certificate age, etc.), ownership entity of the network resource (e.g., identity of domain name registrant, domain name registrar, domain owner, etc.), geographical location (e.g., of the host, of the domain name, of the IP address, of the DNS server, etc.), traffic telemetry (for example, number of visitors, number of enterprise visitors, change in number of visitors, change in number of enterprise visitors, change in rate of visitors, change in rate of enterprise visitors, visit denial numbers, visit denials to enterprise visitors, etc.), typo squatting (e.g., similarity to another domain name, detection of specific typos—for example “teh” instead of “the”—in domain names, etc.), phishing domain probability (for example, similarity in second-level domain (SLD) with difference in top-level domain (TLD)), or any other appropriate risk attributes. The risk attributes may be global (e.g., as provided by a third-party service to substantially all customers) or enterprise specific. For example, risk attributes may include identification of network resources as competitor-related, unfriendly-nation-related (e.g., hosted in an unfriendly nation, belonging to an unfriendly nation, etc.), or any other enterprise-related risk category or attribute. In some embodiments, the machine learning model trained to determine the risk level for a network resource may be trained using a set of network resources and their risk levels, such as risk attributes, verdicts, etc.—which may be provided by any appropriate third-party service or by any other appropriate method—to determine risk levels for a given network resource, including without or without classification (e.g., by topic) of the network resource.

At block 1106, in some embodiments, the machine learning model may be used to determine a risk level for a network resource. The machine learning model may operate on any appropriate input, such as the web address of the network resource, content of the network resource, or any other corresponding data such as previously described. The machine learning model may generate any appropriate output, such as a verdict (e.g., block, allow, isolate, restrict, etc.) for a given user, group of users, a universal verdict, etc. In some embodiments, the machine learning model may generate as output a final verdict, which may be used to determine a category for provision of the network resource (for example, as will be described in relation to block 1008). In some embodiments, the machine learning model may generate an intermediate verdict, which may be used, such as together with output from a machine learning model trained to classify a network resource, to provide a final verdict. In some embodiments, the machine learning model may operate on input of a machine learning model trained to classify a network resource in order to generate a final verdict. In some embodiments, the output of the machine learning model trained to classify the network resource and the output of the machine learning model trained to determine the risk level of the network resource may be used together, such as by another machine learning model, by a set of rules, etc., to generate a final verdict. In some embodiments, the verdict may be a time limited verdict (e.g., may have an expiration time). In some embodiments, the output of the machine learning model trained to determine the risk level of the network resource may be time limited, while the output of the machine learning model trained to classify the network resource may not be time limited, or vice versa.

At block 1108, in some embodiments, a category for the network resource may be determined, based on the determined risk level. The category may be used to determine a classification of the network resource, a category of action to take with respect to provisioning of the network resource, etc.

FIG. 12 is an example of a data flow diagram 1200 of browsing enforcement based on key rotation in a multi-user network, in accordance with some embodiments of the present disclosure. In the illustrated example, a verdict service 1210 and a proxy service 1220 may implement browsing enforcement based on key rotation. Browsing enforcement is a process in which access to an external network, such as the Internet, is restricted. For example, access to the external network may be restricted so that only authorized clients from within the multi-user network (also referred to herein as an “internal network”) are granted permission to access the external network. Access to a subset or all of the external network may be restricted. For example, subset restrictions may be based on whitelists, blacklists, other subset of external network access. Alternatively, access to the external network may be completely restricted. Key rotation is a process in which a new key is periodically generated after a key rotation interval and replaces a prior key as the current key. The key rotation interval is a time period after which a new key is to be generated. The key rotation interval may be a minute, an hour, a day, and/or other time period. Through rotating key access, the prior key cannot be reused beyond the key rotation interval. Shorter key rotation intervals may be more secure but at the cost of more frequent updates.

Browsing enforcement based on key rotation is an enforcement mechanism in which clients are required to prove possession of a rotating key (such as the most recent, or “current” key) in order to release the partial or full restriction on accessing the external network from the internal network. For example, a browser client will need to prove possession of a rotating key to be granted access to the external network from within the internal network. In a particular example, a browsing client will need to be equipped with a specific plugin that is periodically provided with a rotating key. Other clients or plugins that do not have access to the rotating key will not be permitted access to the external network. These clients or plugins will be restricted from browsing the external network from within the internal network.

Browsing enforcement based on key rotation may be used in various contexts. In some examples, the flow diagram 1200 may be implemented to enforce a policy that requires that only certain authorized clients, such as web browser plugins, are able to access the external network from within the internal network. In some examples, the flow diagram 1200 may be implemented to grant or deny access to specific resources. For example, specific types of keys 1214 may be generated for a specific network resource so that access to the network resource is restricted to clients having possession of the current key for that network resource.

The verdict service 1210 includes a key generator 1212. The key generator 1212 may perform key rotation to generate a key 1214 at one or more key rotation intervals. For embodiments in which rapid proof is desired, the key 1214 is encoded in a way that permits efficient match comparison to show possession of the key 1214. For example, in some of these embodiments, the generator 1212 randomly generates the key 1214 with high entropy using a random number generator. In these examples, proof of possession of the key 1214 may be made through an efficient number match. In some examples, the key 1214 may include numbers, characters, symbols, and/or other value, some or all of which may be randomly generated. For embodiments in which higher security is desired at the cost of encryption, encoding, decryption, or decoding time, the key generator 1212 may encrypt, hash, or otherwise encode the key 1214 to obfuscate clear text.

The verdict service 1210 may provide the key 1214 for provision to a client with key access 1202A and a proxy service 1220. The client with key access 1202A is a client that is provided with the key 1214. For example, the client with key access 1202A may include a browser application with a specific plugin or other application. Other (non-approved) clients without key access 1202B, such as browsers that do not have the specific plugin installed or other client applications or interfaces not approved for external network access, will not be provided with the key 1214. In some examples, the verdict service 1210 may provide the key to an agent service 1230, which distributes the key 1214 to the client with key access 1202A. Each time the client with key access 1202A, receives a new key 1214, the client will replace a previously received key with the new key. When requesting access to the external network (such as when attempting to browse the Internet from an internal network), the client with key access 1202A may transmit the key 1214 to a proxy 1220. For example, the client with key access 1202A may include the key 1214 with the request. In a particular example, the client with key access 1202A may include the key 1214 in a header of a HyperText Transfer Protocol (“HTTP”) request. In other examples, the client with key access 1202A may include the key 1214 as a meta tag, Uniform Resource Locator (“URL”) query parameter, request body, and/or other ways to transmit data from a client to a server. In some examples, the client with key access 1202A may obfuscate the key 1214 in the transmission, such as by identifying or otherwise indicating the key 1214 using an obfuscated name so that malicious actors or code will not readily be able to access the key 1214 in the HTTP header, meta tag, URL query parameter, request body, or other data transmission.

The proxy 1220 is hardware and/or software that acts as an intermediary between clients in an internal network and resources on an external network. When a client on an internal network requests access to a resource on the external network (such as by requesting to browse to an external website from within an internal network), the request is transmitted to the proxy 1220. The proxy 1220 may verify that the requesting client has possession of the key 1214. If so, the proxy 1220 grants access, and forwards the request to the external network.

Thus, the proxy 1220 may manage browsing traffic and other external network requests, and determines whether to allow or block the browsing traffic based on browser enforcement and key rotation. For example, a requesting client must have installed a specific plugin or agent that has access to a current key 1214. This may prevent use of clients that do not have the specific plugin or agent to access the external network. To illustrate, a user will need to install a specific plugin in order to browse the Internet.

To facilitate browser enforcement, the proxy configuration may have a rule that retrieves or otherwise accesses a rotating key 1214 on the key rotation interval. The key 1214 may be embedded on a scheduled basis into the allow rules of the proxy 1220. When a request to access the external network is received from a client, the proxy 1220 may determine whether the client has possession of the (current) key 1214 and permit access if the client transmitted the key 1214. For example, the proxy 1220 may parse the HTTP header to determine whether the key 1214 is present. If so, the proxy 1220 may allow the traffic to and from the external network to pass. If not, then the proxy 1220 may deny access.

It should be noted that the verdict service 1210 is an implementation of the verdict service 110 and may perform some or all of the functions of the verdict service 110. Put another way, in addition to or instead of various functionality described with respect to the verdict service 110 illustrated in FIG. 1 and elsewhere herein, the verdict service 120 may be programmed to perform the functions of the verdict service 1210 illustrated in FIG. 12.

FIG. 13 illustrates an example of a method 1300 for browsing enforcement based on rotating key access in a multi-user network, in accordance with some embodiments of the present disclosure. At 1302, a key generator (such as the key generator 1212) may generate a key (such as key 1214). At 1304, a verdict service (such as the verdict service 1210) may provide the key to a proxy (such as proxy 1220) and to a key agent (such as the key agent 1230). The proxy may permit or deny access to an external network based on whether or not the requestor has possession of current key. The key agent may identify authorized clients that have permission to access the external network and provides the key to the identified clients.

At 1306, the proxy service may receive a request to access the external network. At 1308, the proxy service may determine whether the requesting client provided a current key. If the client provided the current key, at 1310, the proxy may grant access to the external network. If the client has not provided the current key, at 1312, the proxy may deny access to the external network.

Periodically, at 1305, the verdict service may determine whether the key rotation should be performed. For example, the verdict service may determine whether the key rotation interval since the last key generation has elapsed. If so, the verdict service may return to 1302 and generate a new key to replace the previously generated key.

FIG. 14 illustrates a schematic example 1400 of proprietary code management with public application stores, in accordance with some embodiments of the present disclosure. A public application store 1401 is a repository to which software providers upload software for download at an endpoint 1430 via the external network. In some examples, the public application store 1401 may store and provide browser-related software such as plugins. In these examples, the public application store 1401 may provide a browser plugin 1402 for execution by a browser 1432 at the endpoint 1430.

Public application stores (including public application store 1401) provide an effective way to distribute software because of their centralized and well-known nature. For example, different software platforms such as operating systems may each have their own public application stores that are well known locations for downloading software. While enabling an effective way for software providers to make software available for their users, public application stores may expose the software to the public. This could expose proprietary code, functionality, configurations, and/or other information that can be obtained from the software to be compromised. Oftentimes, as a convenient way to distribute a plugin or other software to their users, an organization may upload plugins or software for use only inside an internal network. However, this may expose the plugin or software to the public since the public application store 1401 makes software available on the external network.

To address this problem, the browser plugin 1402 at the application store 1401 may include shell code 1403. The shell code 1403 is a basic configuration that enables the browser plugin 1402 to obtain an internal configuration 1404 when executed from within the internal network. The internal configuration is software and/or configuration data that provides plugin functionality. If executed from a location outside the internal network, the browser plugin 1402 and the shell code 1403 is unable to access the internal configuration 1404. Thus, the internal configuration 1404 is not exposed to the public outside the internal network, while enabling the browser plugin 1402 to be made available at a public application store 1401.

In some examples, the shell code 1403, when executed at the endpoint 1430, may look for a local agent 1434. The local agent 1434 may be pre-installed at the endpoint 1430. The shell code 1403 may look for the local agent 1434. In one example, the local agent 1434 may be implemented as a native host that is registered with the browser 1432 via a manifest. The native host manifest may include a name of the native host that the shell code 1403 uses to identify and communicate with the local agent 1434. In these examples, the shell code 1403 may be associated with a shell code manifest. The native host manifest and the shell code manifest may be configured as a JavaScript Object Notation (“JSON”) formatted message.

If the shell code 1403 finds the local agent 1434 (such as based on the native host name used by the local agent 1434), then the shell code 1403 may communicate with the local agent 1434 to achieve the internal configuration 1404. The communication between the shell code 1403 and the local agent 1434 may be through native host standard input and output. In some examples, the communication may be formatted as messages in a standardized format, such as JSON messages, from and to the native host standard input and output.

In some examples, the internal configuration 1404 may be achieved based on interactions between the local agent 1434 and the shell code 1403 for subsequent decision making for proprietary functionality. In these examples, the local agent 1434 may include code for proprietary functionality that is used by the browser plugin 1402 to perform one or more plugin functions. In these examples, the internal configuration 1404 is a combination of the shell code 1403 and the functionality provided by the local agent 1434. If the local agent 1434 is not found or is unavailable, then the plugin functions are not available to the browser plugin 1402.

In some examples, the internal configuration 1404 may be achieved based on the local agent 1434 providing internal code or data to the shell code 1403 for execution by the browser plugin 1403. The internal code or data may then be executed by the browser plugin 1403 for proprietary functionality.

Thus, according to various examples, internal code and/or data may be executed in cooperation by the local agent 1434 and the shell code 1403 or the local agent 1434 may provide the internal code or data to the shell code 1403 for execution by the browser plugin 1402. In either instance, in some examples, the internal code and/or data may be provided by the verdict server 1420 or other system component. In these examples, the verdict server 1420 may identify the shell code 1403, identify stored internal code and/or data based on the shell code 1403, and transmit the identified internal code and/or data to the local agent 1434. In particular, the shell code 1403 may include a shell code identifier that is stored in association with the internal code and/or data. In this way, the internal code and/or data may be customized for specific browser plug-ins 1402. Further in these examples, code changes, bug fixes, and other updates may be seamlessly provided to the browser plug-ins 1402.

FIG. 15 is a schematic of a computing system, in accordance with some embodiments of the present disclosure. FIG. 15 is a diagram that illustrates an exemplary computing system 1500 in accordance with embodiments of the present disclosure. Various portions of systems and methods described herein may include or be executed on one or more computing systems similar to computing system 1500. Further, processes and modules described herein may be executed by one or more processing systems similar to that of computing system 1500.

Computing system 1500 may include one or more processors (e.g., processors 1510a-1510n) coupled to system memory 1520, an input/output I/O device interface 1530, and a network interface 1540 via an input/output (I/O) interface 1550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1520). Computing system 1500 may be a uni-processor system including one processor (e.g., processor 1510a), or a multi-processor system including any number of suitable processors (e.g., 1510a-1510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1500 may include a plurality of computing devices (e.g., distributed computing systems) to implement various processing functions.

I/O device interface 1530 may provide an interface for connection of one or more I/O devices 1561560 to computing system 1500. I/O devices may include devices that receive input (e.g., from a user) or output information (e.g., to a user). I/O devices 1561560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1561560 may be connected to computing system 1500 through a wired or wireless connection. I/O devices 1561560 may be connected to computing system 1500 from a remote location. I/O devices 1561560 located on remote computing system, for example, may be connected to computing system 1500 via a network and network interface 1540.

Network interface 1540 may include a network adapter that provides for connection of computing system 1500 to a network. Network interface 1540 may facilitate data exchange between computing system 1500 and other devices connected to the network. Network interface 1540 may support wired or wireless communication. The network may include an electronic communication network, such as the Internet, a local area network (LAN), a wide area network (WAN), a cellular communications network, or the like.

System memory 1520 may be configured to store program instructions 1570 or data 1580. Program instructions 1570 may be executable by a processor (e.g., one or more of processors 1510a-1510n) to implement one or more embodiments of the present techniques. Instructions 1570 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1520 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 1520 may include a non-transitory computer readable storage medium that may have program instructions stored thereon that are executable by a computer processor (e.g., one or more of processors 1510a-1510n) to cause the subject matter and the functional operations described herein. A memory (e.g., system memory 1520) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1550 may be configured to coordinate I/O traffic between processors 1510a-1510n, system memory 1520, network interface 1540, I/O devices 1561560, and/or other peripheral devices. I/O interface 1550 may perform protocol, timing, or other data transformations to convert data signals from one component (e.g., system memory 1520) into a format suitable for use by another component (e.g., processors 1510a-1510n). I/O interface 1550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1500 or multiple computing systems 1500 configured to host different portions or instances of embodiments. Multiple computing systems 1500 may provide for parallel or sequential processing/execution of one or more portions of the techniques described herein.

Those skilled in the art will appreciate that computing system 1500 is merely illustrative and is not intended to limit the scope of the techniques described herein. Computing system 1500 may include any combination of devices or software that may perform or otherwise provide for the performance of the techniques described herein. For example, computing system 1500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1200 may be transmitted to computing system 1200 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1200 may be transmitted to computing system 1200 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, the applicant has grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B may include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

Grouped, numerated embodiments are listed below by way of example.

Reference to prior characterizations of embodiments within are within each group.

### Embodiments

1. A non-transitory computer-readable medium storing instructions that, when executed by a processor, programs the processor to: obtain a request to access a network resource; determine that the network resource is an unclassified network resource; responsive to the determination that the network resource is an unclassified network resource: classify, by one or more machine learning models, the network resource with one or more classifications; identify a category of action for access to the network resource based on the one or more classifications; and permit or deny access to the network resource based on the category of action.
2. The medium of claim 1, wherein to classify the network resource, the instructions further program the processor to: access a user profile for a user associated with the request, wherein the one or more classifications are based on the user profile.
3. The medium of claim 1 or 2, wherein to identify a category of action for access to the network resource, the instructions further program the processor to: access a user profile for a user associated with the request, wherein the category of action is based on the user profile.
4. The medium of any preceding claim, wherein the category of action for supplying access to the network resource comprises one or more of the following: provide access to the network resource, block access to the network resource, provide an isolated version of the network resource, prevent input to one or more fields of the network resource, prevent upload to the network resource, prevent print of the network resource, prevent download from the network resource, prevent display of images associated with the network resource, provide a reminder to a user about security policy, provide a reminder to the user about user name, password, or other credential security, and generate an alert to a security apparatus.
5. The medium of any preceding claim, wherein the category of action for supplying access to the network resource comprises provide access to the network resource for a limited time duration.
6. The medium of claim 5, wherein providing access to the network resource comprises blocking access to the network resource after expiration of the limited time duration.
7. The medium of any preceding claim, wherein classifying the network resource further comprises classifying the network resource based on user input associated with the request to access the network resource.
8. The medium of claim 7, wherein the network resource comprises a website and the request to access the network resource comprises a web address.
9. The medium of claim 7, wherein the network resource comprises a website and the request to access the network resource comprises a user input to one or more fields in the website.
10. The medium of claim 9, further comprising determining if the user input to the one or more fields in the website comprises one or more of a username, a password, or other credentials and classifying or re-classifying the network resource based on the user input.
11. The medium of any of claims 7 to 11, wherein the user input associated with navigating to the network resource comprises opening a link from an email.
12. The medium of any preceding claim, wherein the one or more classifications comprise one or more classification based on content of the network resource.
13. The medium of any preceding claim, wherein the one or more classifications comprise one or more of the following: membership in a block list, membership in an allow list, membership in a conditional block list, and membership in a conditional allow list.
14. The medium of any preceding claim, wherein the one or more machine learning models classify the said unclassified network resource based on a fully qualified domain name (FQDN).
15. The medium of any preceding claim, wherein the one or more machine learning models classify the network resource based on content associated with the network resource.
16. The medium of any preceding claim, wherein the one or more machine learning models classify the network resource based on latent Dirichlet allocation (LDA).
17. The medium of any preceding claim, wherein the one or more machine learning models determine one or more topical category for the network resource and the network resource is classified based on classifications associated with the one or more topical category.
18. The medium of any preceding claim, further comprising tracking a number of users navigating to the network resource and classifying or re-classifying the network resource based on the number of users.
19. The medium of any preceding claim, further comprising tracking a change in a number of users navigating to the network resource and classifying or re-classifying the network resource based on the change in the number of users.
20. The medium of any preceding claim, further comprising tracking a number of a set of users or a change in a number of the set of users navigating to the network resource and classifying or re-classifying the network resource based on the number of the set of users of the change in the number of the set of users, wherein the set of users are identified based on characteristics of one or more user profiles.
21. The medium of any preceding claim, further comprising logging of the action for supplying of the network resource to a user or logging of a user input associated with navigating to the network resource.
22. A system comprising: a processor programmed to: obtain a request to access a network resource; determine, responsive to the request, whether the corresponding network resource comprises a classified network resource or an unclassified network resource; based on a determination that the corresponding network resource is an unclassified network resource, classify, by one or more machine learning models, the network resource; identify a category of action for access to the network resource; and
bprovide, according to the identified category of action, access to the network resource.
23. The system of claim 22, wherein the request is obtained from an interface configured to accept user input corresponding to navigation to a network resource.
24. The system of claim 22 or 23, the system further comprising memory and the processor further programmed to determine if the corresponding network resource comprises a classified network resource or an unclassified network resource based on a list of classified network resources stored in one or more of the following: local cache, static cache, dynamic cache, a user profile, a network resource database, and a machine learning model output database, wherein the memory comprises the one or more of the following: local cache, static cache, dynamic cache, a user profile, a network resource database, and a machine learning model output database.
25. The system of any of claims 22 to 24, wherein the determination that the corresponding network resource comprises a classified network resource or an unclassified network resource is a time-limited determination, the processor further configured to: based on a determination that the determination is expired, classifying or re-classify, by the one or more machine learning models, the said network resource.
26. The system of any of claims 22 to 25, wherein the processor is further configured to: determine if the corresponding network resource comprises a classified network resource or an unclassified network resource based on a user profile and classify, by one or more machine learning models, the network resource based on the user profile.
27. The system of claim 26, the system further comprising a user profile database, wherein the processor is further configured to access a user profile from the user profile database.
28. The system of claim 26, the processor further programmed to: provide an interface configured to accept user input corresponding to a user name and password; validate the user name and password; and determine, based on the validated user name and password, a user profile.
29. The system of claim 28, wherein the interface is further configured to accept user input corresponding to an access time duration, the processor further programmed to: provide, according to the identified category of action, the network resource according to the access time duration.
30. The system of any of claims 22 to 29, wherein the identified category of action comprises one or more of the following: provide access to the network resource, block access to the network resource, provide an isolated version of the network resource, prevent input to one or more fields of the network resource, prevent upload to the network resource, prevent print of the network resource, prevent download from the network resource, prevent display of images associated with the network resource, provide a reminder to a user about security policy, provide a reminder to the user about user name, password, or other credential security, and generate an alert to a security apparatus.
31. The system of claim 22, wherein the processor is further programmed to: responsive to the request, determine that the request includes a current key that is generated during a key rotation.
32. The system of claim 31, wherein to determine that the request includes the current key, the processor is further programmed to: parse a HyperText Transfer Protocol (HTTP) header from a packet associated with the request; and determine whether the current key is included in the HTTP header.
33. The system of claim 1, wherein the request is transmitted from a browser plugin and wherein the browser plugin is pre-installed with shell code, and wherein the processor is further programmed to: receive a request to provide an internal configuration to the shell code; and transmit the internal configuration to the browser shell code for execution by the browser plugin.
34. A method for controlling access to a network resource comprising: receiving, from a user computing device, a request to access a network resource; determining, with a computing system, that the network resource is an unclassified network resource; responsive to the determination the network resource is an unclassified network resource, classifying, by one or more machine learning model, the network resource with one or more classification; identifying, with the computing system, a category of action for access to the network resource based on the one or more classifications; and
providing, with the user computing device, access to the network resource based on the category of action.
35. A system, comprising: a key generator programmed to generate a key; a proxy service programmed to permit or deny access to an external network; a key agent programmed to identify clients having permission to access the external network; a verdict service programmed to provide the key to the proxy service and to the key agent; wherein the key agent is further programmed to: periodically receive the key; provide the key to one or more clients that have permission to access the external network; and wherein the proxy service is further programmed to: periodically receive the key and associates the key as a current key; receive a request to access the external network from a client; determine whether the client provided a current key; and permit or deny access to the external network based on the determination of whether the client provided the current key.
36. The system of claim 35, wherein to determine whether the client provided the current key, the proxy service is further to: parse a HyperText Transfer Protocol (HTTP) header from a packet associated with the request and transmitted from the client; determine whether the current key is included in the HTTP header.
37. The system of claim 35, wherein the request from the client is from a browser plugin that is made available via a public application store, the browser plugin having shell code that, when executed by the browser plugin within an internal network, accesses an internal configuration that is not exposed to the public application store, and wherein the verdict service is further programmed to: identify the internal configuration associated with the shell code; and provide the internal configuration to the browser plugin.

It should be understood that the present invention is not limited to the above-described techniques, features or aspects. Instead, the specific details described above are disclosed as example forms of implementing the claims, as set forth below.

1. A non-transitory computer-readable medium storing instructions that, when executed by a processor, programs the processor to:
obtain a request to access a network resource;
determine that the network resource is an unclassified network resource;
responsive to the determination that the network resource is an unclassified network resource: classify, by one or more machine learning models, the network resource with one or more classifications that indicate a risk level associated with the network resource;
identify a category of action for access to the network resource based on the one or more classifications; and
permit or deny access to the network resource based on the category of action.

2. The medium of claim 1, wherein to classify the network resource, the instructions further program the processor to: access a user profile for a user associated with the request, wherein the one or more classifications are based on the user profile.

3. The medium of claim 1, wherein to identify a category of action for access to the network resource, the instructions further program the processor to:
access a user profile for a user associated with the request, wherein the category of action is based on the user profile.

4. The medium of claim 1, wherein the category of action for supplying access to the network resource comprises one or more of the following: provide access to the network resource, block access to the network resource, provide an isolated version of the network resource, prevent input to one or more fields of the network resource, prevent upload to the network resource, prevent print of the network resource, prevent download from the network resource, prevent display of images associated with the network resource, provide a reminder to a user about security policy, provide a reminder to the user about user name, password, or other credential security, and generate an alert to a security apparatus.

5. The medium of claim 1, wherein the category of action for supplying access to the network resource comprises provide access to the network resource for a limited time duration.

6. The medium of claim 5, wherein providing access to the network resource comprises blocking access to the network resource after expiration of the limited time duration.

7. The medium of claim 1, wherein classifying the network resource further comprises classifying the network resource based on user input associated with the request to access the network resource.

8. The medium of claim 7, wherein the network resource comprises a website and the request to access the network resource comprises a web address.

9. The medium of claim 7, wherein the network resource comprises a website and the request to access the network resource comprises a user input to one or more fields in the website.

10. The medium of claim 9, further comprising determining if the user input to the one or more fields in the website comprises one or more of a username, a password, or other credentials and classifying or re-classifying the network resource based on the user input.

11. The medium of claim 7, wherein the user input associated with navigating to the network resource comprises opening a link from an email.

12. The medium of claim 1, wherein the one or more classifications comprise one or more classification based on content of the network resource.

13. The medium of claim 1, wherein the one or more classifications comprise one or more of the following: membership in a block list, membership in an allow list, membership in a conditional block list, and membership in a conditional allow list.

14. The medium of claim 1, wherein the one or more machine learning models classify the said unclassified network resource based on a fully qualified domain name (FQDN).

15. The medium of claim 1, wherein the one or more machine learning models classify the network resource based on content associated with the network resource.

16. The medium of claim 1, wherein the one or more machine learning models classify the network resource based on latent Dirichlet allocation (LDA).

17. The medium of claim 1, wherein the one or more machine learning models determine one or more topic for the network resource and the network resource is classified based on classifications associated with the one or more topic.

18. The medium of claim 1, further comprising tracking a number of users navigating to the network resource and classifying or re-classifying the network resource based on the number of users.

19. The medium of claim 1, further comprising tracking a change in a number of users navigating to the network resource and classifying or re-classifying the network resource based on the change in the number of users.

20. The medium of claim 1, further comprising tracking a number of a set of users or a change in a number of the set of users navigating to the network resource and classifying or re-classifying the network resource based on the number of the set of users of the change in the number of the set of users, wherein the set of users are identified based on characteristics of one or more user profiles.

21. The medium of claim 1, further comprising logging of the action for supplying of the network resource to a user or logging of a user input associated with navigating to the network resource.

22. A system comprising:
a hardware processor programmed to:
obtain a request to access a network resource;
determine, responsive to the request, whether the corresponding network resource comprises a classified network resource or an unclassified network resource;
based on a determination that the corresponding network resource is an unclassified network resource, classify, by one or more machine learning models, the network resource based on a risk level associated with the network resource;
identify a category of action for access to the network resource; and
provide, according to the identified category of action, access to the network resource.

23. The system of claim 22, wherein the request is obtained from an interface configured to accept user input corresponding to navigation to a network resource.

24. The system of claim 22, the system further comprising memory and the hardware processor further programmed to determine if the corresponding network resource comprises a classified network resource or an unclassified network resource based on a list of classified network resources stored in one or more of the following: local cache, static cache, dynamic cache, a user profile, a network resource database, and a machine learning model output database, wherein the memory comprises the one or more of the following: local cache, static cache, dynamic cache, a user profile, a network resource database, and a machine learning model output database.

25. The system of claim 22, wherein the determination that the corresponding network resource comprises a classified network resource or an unclassified network resource is a time-limited determination, the hardware processor further configured to:
based on a determination that the determination is expired, classifying or re-classify, by the one or more machine learning models, the said network resource.

26. The system of claim 22, wherein the hardware processor is further programmed to:
responsive to the request, determine that the request includes a current key that is generated during a key rotation.

27. The system of claim 26, wherein to determine that the request includes the current key, the hardware processor is further programmed to:
parse a HyperText Transfer Protocol (HTTP) header from a packet associated with the request; and
determine whether the current key is included in the HTTP header.

28. The system of claim 22, wherein the request is transmitted from a browser plugin and wherein the browser plugin is pre-installed with shell code, and wherein the hardware processor is further programmed to:
receive a request to provide an internal configuration to the shell code; and
transmit the internal configuration to the browser shell code for execution by the browser plugin.

29. A method for controlling access to a network resource comprising:
receiving, from a user computing device, a request to access a network resource;
determining, with a computing system, that the network resource is an unclassified network resource;
responsive to the determination the network resource is an unclassified network resource, classifying, by one or more machine learning model, the network resource with one or more classification that indicates a risk level associated with the network resource;
identifying, with the computing system, a category of action for access to the network resource based on the one or more classifications; and
providing, with the user computing device, access to the network resource based on the category of action.

30. (canceled)

31. The medium of claim 1, wherein the one or more classifications that indicate a risk level of the network resource indicate a category of harmfulness to network security associated with access to the network resource.
